(19) United States
(12) Patent Application Publication
(10) Pub. No.: US 2025/0222578 A1
(43) Pub. Date: Jul. 10, 2025

(54) FASTENER DRIVING TOOL

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/004,843

(22) Filed: Dec. 30, 2024

(30) Foreign Application Priority Data
Jan. 10, 2024 (CN) 2024100378324
Jun. 3, 2024 (CN) 2024107127454

(51) Int. Cl. B25C 1/04; B25C 1/00; B25C 1/06

(52) U.S. Cl. CPC B25C 1/047; B25C 1/008; B25C 1/06

(57) ABSTRACT

A fastener driving tool includes: an energy accumulation assembly, a striker, and a drive assembly which includes a power unit, a drive wheel, and a transmission construction, the power unit provided with an output shaft, the drive wheel fitted with the striker, the drive assembly provided with the transmission construction, the transmission construction having an engaged state and a disengaged state, the power shaft driving, via the transmission construction in the engaged state, the drive wheel to rotate forwardly so that the forwardly rotating drive wheel drives the striker and the piston to move upward to return in place; the transmission construction is in the disengaged state during a process of the piston driving the striker to move from a ready position to a striking position so that the drive wheel fitted with the striker may be driven by the downwardly moving striker to rotate reversely.

### FIELD

The subject matter described herein relates to a power tool, and more particularly relates to a fastener driving tool.

### BACKGROUND

A nail gun is a handheld tool for driving nails, which leverages a fast-moving firing pin to drive a nail into a workpiece such as wood. Dependent on different drive sources, nail guns may be classified into electric nail guns, pneumatic nail guns, and manual nail guns. An existing pneumatic nail gun generally adopts a dual-cylinder construction, where after a large piston in a larger cylinder moves to compress air in the larger cylinder to a predetermined degree, a piston in a smaller cylinder is released, so that the compressed air in the larger cylinder flows through an air passage into the smaller cylinder to push the small piston in the smaller cylinder to move fast, the fast-moving small piston driving the firing pin to move synchronously, the fast-moving firing pin driving a nail into a workpiece such as wood, whereby nail driving is implemented. The existing pneumatic nail gun usually leverages a crank-connecting rod construction to drive the large piston in the larger cylinder to move to compress air. The crank-connecting rod construction is likely subjected to a large slip angle during its reciprocating motion; if the connecting rod has a too large pivotal angle or eccentric angle, issues such as instable thrust and high unbalanced load would occur during a process of the crank-connecting rod structure driving the large piston to compress air, which would cause the large piston jammed during the process of air compressing, resulting in deteriorated work efficiency and nail driving effect of the nail gun.

### SUMMARY

To overcome the above and other drawbacks in conventional technologies, the disclosure provides a fastener driving tool, in which a rotating direction of a drive wheel is adapted to a movement direction of a striker so that a drive assembly may drive, via the drive wheel, the striker and a piston to move upward to return in place; this ensures a stable thrust driving the piston and the striker to return in place, eliminates a jamming issue of the drive wheel rotating about its own central axis, and enhances movement smoothness of the striker during a return process.

A fastener driving tool described herein comprises:
an energy accumulation assembly comprising a cylinder construction and a piston, the cylinder construction having an energy accumulation chamber, the piston being arranged in the cylinder construction, in the energy accumulation chamber being filled an energy accumulation medium, the piston moving to change a volume of the energy accumulation chamber so as to induce pressure change of the energy accumulation medium;
a striker connected to the piston, the piston driving the striker to move from a top dead center to a bottom dead center so that the striker drives a fastener into a workpiece;
and a drive assembly comprising a power unit and a drive wheel, the power unit driving, via the drive wheel, the striker and the piston to move upward from the bottom dead center to return in place;
the power unit is provided with an output shaft, the drive wheel is fitted with the striker, the drive assembly is provided with a transmission construction, and the transmission construction has an engaged state and a disengaged state;
the output shaft transmits, via the transmission construction in the engaged state, power to the drive wheel to actuate the drive wheel to rotate forwardly, so that the drive wheel rotating forwardly drives the striker and the piston to move upward from the bottom dead center to return in place;
and the transmission construction is in the disengaged state during a process of the piston driving the striker to move from the top dead center to the bottom dead center; and the transmission construction in the disengaged state interrupts transmission of power from the output shaft to the drive wheel, so that the drive wheel fitted with the striker is driven to rotate reversely by the striker moving downwardly.

In some implementations, the drive assembly further comprises a a rotary shaft, the drive wheel being arranged on the rotary shaft, the drive wheel and the rotary shaft rotating synchronously, the transmission construction being arranged between the output shaft and the rotary shaft or arranged between the output shaft and the drive wheel.

With the technical solutions above, the disclosure offers the following advantages:

1. According to the fastener driving tool described herein, the power unit of the drive assembly is provided with an output shaft, the drive wheel of the drive assembly is fitted with the striker, and the drive assembly is further provided with a transmission construction having an engaged state and a disengaged state. In a need of driving the striker and the piston to move upward to return in place, the transmission construction is in the engaged state; now, the output shaft of the power unit may drive, via the transmission construction, the drive wheel to rotate forwardly, the forwardly rotating drive wheel drives, via fitting with the striker, the striker and the piston to move upward from the bottom dead center to return in place, the upward moving piston compresses the energy accumulation medium in the energy accumulation chamber to increase the pressure of the energy accumulation medium. In a need of driving a fastener such as a nail into a workpiece, the pressurized energy accumulation medium in the energy accumulation chamber applies a force against the piston so that the piston may drive the striker to move from the top dead center to the bottom dead center; during this process, since the transmission construction is in the disengaged state, the power cannot be transmitted from the output shaft to the drive wheel, disposing the drive wheel in a free state relative to the output shaft, so that the downwardly moving striker may drive the drive wheel to rotate reversely, while the reversely rotating drive wheel would not transmit a torque to the output shaft; as such, the drive wheel would not hamper downward movement of the striker, and the piston may drive the striker to move downward smoothly. With this reasonable setting of the drive assembly, the output shaft and the drive wheel of the drive assembly may switch to transmission engagement or transmission disengagement on demand, the output shaft may maintain unidirectional rotation during a process of up-down movement of the striker, so that the power unit needn't switch the drive direction during operation of the tool, which ensures performance stability of the power unit and enhances output efficiency of the power unit. Since the drive wheel may rotate reversely relative to the output shaft when the transmission construction is in the disengaged state, the drive wheel driven by the striker to rotate reversely does not hamper striking movement of the striker, so that the striker may strike the fastener smoothly. Since the rotation direction of the drive wheel may be adapted to the movement direction of the striker, the drive assembly may smoothly drive, via the drive wheel, the striker and the piston to move upward to return in place, which ensures a stable thrust in driving the piston and the striker to return in place, and the drive wheel rotating about its own central axis would not be jammed in a case of high unbalanced load, which enhances movement smoothness during a process of the striker returning in place, whereby nail driving efficiency and nail driving effect are ensured and user experience is enhanced.

### BRIEF DESCRIPTION OF THE DRAWINGS

FIG. 1 is an overall view of a fastener driving tool according to a first implementation;

FIG. 2 is a stereoscopic view of partial structure in the first implementation;

FIG. 3 is a stereoscopic view of another partial structure in the first implementation;

FIG. 4 is a structural view of an energy accumulation assembly and a striker in the first implementation;

FIG. 5 is an exploded view of a cylinder base, a support base, and a guide seat in the first implementation;

FIG. 6 is a sectional view of the support base, the guide seat and the striker perpendicular to a vertical direction in the first implementation;

FIG. 7 is a diagram of fitting between the striker and a drive wheel in the first implementation;

FIG. 8 is an exploded view of a drive assembly in the first implementation;

FIG. 9 is an axially sectional view of a speed reducer in the first implementation;

FIG. 10 is an exploded view of the speed reducer in the first implementation;

FIG. 11 is a structural view of partial structure of the drive assembly and a latch in the first implementation;

FIG. 12 is an axially sectional view of partial structure of the drive assembly in the first implementation;

FIG. 13 is a stereoscopic view of a transmission construction in the first implementation;

FIG. 14 is a structural diagram of transmission ratchet teeth in the first implementation;

FIG. 15 is a structural diagram of master wheel I in the first implementation;

FIG. 16 is a structural diagram of slave wheel I in the first implementation;

FIG. 17 is a structural diagram of the drive wheel, an unlocking member, and the latch in the first implementation;

FIG. 18 is a structural diagram of the latch, a locking spring, and a locking switch in the first implementation;

FIG. 19 is a structural diagram of fitting between a rest plate construction and the latch;

FIG. 20 is a schematic diagram of a fitting mechanism between the rest plate construction, the latch, and the locking switch in the first implementation;

FIG. 21 is a connection schematic diagram of an electric element in the first implementation;

FIG. 22 is an exploded view of a safety construction and a guide seat in the first implementation;

FIGS. 23a, 23b, 23c, 23d, and 23e are schematic diagrams of the transmission construction and the striker at different times during the moving process of the striker in the first implementation;

FIG. 24 is an exploded view of the guide seat, an ejection rod, a clasp, a stopper, and a biasing spring in the first implementation;

FIG. 25 is a structural diagram of a second-stage planetary carrier of a speed reducer in a second implementation;

FIG. 26 is an exploded view of a limiting structure in the second implementation;

FIG. 27 is a schematic diagram of fitting between a second-stage ring gear, the second-stage planetary carrier, and the limiting structure in the second implementation;

FIG. 28 is a structural diagram of a drive wheel, an unlocking member, and a latch in a third implementation;

FIG. 29 is a structural diagram of an unlocking member, a striker, a latch, and an output shaft in a fourth implementation;

FIG. 30 is a structural diagram of a transmission construction, a drive wheel, and a striker in a fifth implementation;

FIG. 31 is a structural diagram of a master wheel II in the fifth implementation;

FIG. 32 is a schematic diagram of a drive assembly in the fifth implementation;

FIG. 33 is a structural diagram of a transmission construction, a drive wheel, and a striker in a sixth implementation;

FIG. 34 is a fitting diagram of the transmission construction in the sixth implementation;

FIG. 35 is a schematic diagram of the drive assembly when the transmission construction is in an engaged state in the sixth implementation;

FIG. 36 is a structural diagram of a transmission construction, a drive wheel, and a striker in a seventh implementation;

FIG. 37 is an exploded view of the transmission construction and the drive wheel in the seventh implementation;

FIG. 38 is a schematic diagram of partial structure of the drive assembly when the transmission construction is in an engaged state in the seventh implementation;

FIG. 39 is a schematic diagram of partial structure of the drive assembly when the transmission construction is in a disengaged state in the seventh implementation;

FIG. 40 is a structural diagram of a transmission shaft in the seventh implementation;

FIG. 41 is a structural diagram of a striker and part of a drive assembly in an eighth implementation;

FIG. 42 is a structural diagram of a drive wheel, a speed reducer, and a latch in the eighth implementation;

FIG. 43 is a structural diagram of final-stage transmission of the speed reducer in the eighth implementation;

FIG. 44 is a partial structural diagram in a ninth implementation;

FIG. 45 is a structural diagram of an energy accumulation assembly and a drive assembly in the ninth implementation;

FIG. 46 is a side view of the energy accumulation assembly and part of the drive assembly in the ninth implementation;

FIG. 47 is a structural diagram of the energy accumulation assembly and a striker in the ninth implementation;

FIG. 48 is a local structural view of a locking assembly in a locked state in the ninth implementation;

FIG. 49 is a structural diagram of the locking assembly in the ninth implementation;

FIG. 50 is a sectional view of a locking block along a sliding direction in the ninth implementation;

FIGS. 51a, 51b, 51c, 51d, 51e, and 51f are schematic diagrams of a striker and a piston at different times during a fastener driving process in the ninth implementation;

FIG. 52 is a structural schematic diagram of a piston, a striker, and a locking assembly when the locking assembly is in a locked state in a tenth implementation;

FIG. 53 is a side view of the piston, the striker, the locking assembly and a position switch when the locking assembly is in a locked state in the tenth implementation;

FIG. 54 is a local sectional view of the striker and the locking assembly when the locking assembly is in a locked state in the tenth implementation;

FIG. 55 is a structural diagram of a locking block in a nail gun according to the tenth implementation;

FIGS. 56a, 56b, 56c, 56d, 56e, and 56f are schematic diagrams of the striker and the piston at different times during a fastener driving process in the tenth implementation;

FIG. 57 is a structural diagram of a piston, a striker, a movable member, and a locking assembly in an eleventh implementation;

FIG. 58 is a side view of the piston, the striker, the locking assembly, and a position switch when the locking assembly is in a locked state in the eleventh implementation;

FIG. 59 is a structural view of a locking block in the eleventh implementation;

FIGS. 60a, 60b, 60c, 60d, 60e, and 60f are schematic diagrams of the striker and the piston at different times during a fastener driving process in the eleventh implementation.

### DETAILED DESCRIPTION OF EMBODIMENTS

Hereinafter, the technical solution of the disclosure will be described in detail through specific implementations with reference to the accompanying drawings. It needs to be understood that the orientational or positional relationships indicated by the terms “upper,” “lower,” “left,” “right,” “transverse,” “longitudinal,” “inner,” “outer,” “perpendicular,” “horizontal,” “top,” and “bottom” are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to the disclosure.

### First Implementation

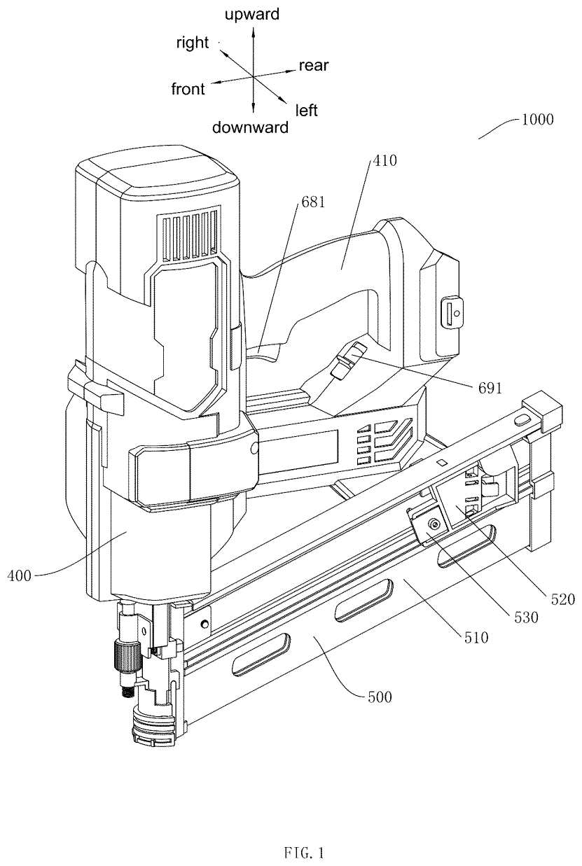

Referring to FIGS. 1 to 24, a fastener driving tool 1000 according to a first implementation of the disclosure comprises:
an energy accumulation assembly 100 comprising a cylinder construction 110 and a piston 120, the cylinder construction 110 having an energy accumulation chamber 111, the piston 120 being arranged in the cylinder construction 110, in the energy accumulation chamber 111 being filled an energy accumulation medium 130, the piston 120 moving to change a volume of the energy accumulation chamber 111 to induce pressure change of the energy accumulation medium 130;
a striker 200 connected to the piston 120, the piston 120 driving the striker 200 to move from a top dead center (TDC) to a bottom dead center (BDC) so that the striker 200 drives a fastener into a workpiece; and
a drive assembly 300 comprising a power unit 310 and a drive wheel 330, the power unit 310 driving, via the drive wheel 330, the striker 200 and the piston 120 to move upward to return in place;
the power unit 310 being provided with an output shaft 3121, the drive wheel 330 being fitted with the striker 200, the drive assembly 300 being provided with a transmission construction 350, the transmission construction 350 having an engaged state and a disengaged state;
the output shaft 3121 transmitting, via the transmission construction 350 in the engaged state, power to the drive wheel 330 so that the drive wheel 330 rotates forwardly, the forwardly rotating drive wheel 330 driving the striker 200 and the piston 120 to move upward from the bottom dead center to return in place;
the transmission construction 350 being in the disengaged state during a process of the piston 120 driving the striker 200 to move from the top dead center to the bottom dead center, the transmission construction 350 in the disengaged state interrupting transmission of power from the output shaft 3121 to the drive wheel 330 so that the drive wheel 330 fitted with the striker 200 is driven to rotate reversely by the striker 200 moving downwardly.

By reasonably setting the drive assembly 300 as noted supra, the output shaft 3121 and the drive wheel 330 of the drive assembly 300 may switch, via the transmission structure 350, to transmission engagement or transmission disengagement on demand; the output shaft 3121 can maintain one-way rotation during up-down movement of the striker 200 so that the power unit 310 needn't shift the drive direction during operating of the tool, which ensures performance stability of the power unit 310 and enhances output efficiency of the power unit 310. When the transmission construction 350 is in the disengaged state, the drive wheel 330 may rotate reversely relative to the output shaft 3121, the drive wheel 330 driven by the striker 200 to rotate reversely does not interfere with a striking movement of the striker 200, so that the striker 200 may smoothly strike the fastener. Since the rotating direction of the drive wheel 300 may be adapted to the movement direction of the striker 200, the drive assembly 300 may drive, via the drive wheel 330, the striker 200 and the piston 120 to move upward to return in place, which ensures a stable thrust in pushing the piston 120 and the striker 200 to return in place; in addition, the drive wheel 330 rotating about its own central axis would not be jammed even under high unbalanced load, which enhances movement smoothness during return of the striker 200 and ensures nail driving efficiency and nail driving effect, whereby user experience is improved.

Referring to FIG. 1, in this implementation, the fastener driving tool further comprises a housing 400 which houses components such as the energy accumulation assembly 100, the striker 200, and the drive assembly 300. The housing 400 exemplarily adopts a structure combining a left half and a right half that are opened in opposite directions; the housing 400 is formed with a handle portion 410 arranged substantially in a front-rear direction, the handle portion 410 being available for a user to hold the tool. The fastener driving tool in this implementation may be powered by a battery pack of 12V, 24V, 36V, 48V, and 60V or the like, or powered by mains electricity via wires. When the fastener driving tool is powered by the battery pack, a battery holder for mounting the battery pack may be set at a rear end of the handle portion 410.

In this implementation, the direction of the piston 120 and the striker 200 moving toward the bottom dead center (BDC) is defined as down, and the direction moving toward the top dead center (TDC) is defined as up.

Referring to FIG. 4, the energy accumulation assembly 100 is provided in a front end of the housing 400. Exemplarily, the cylinder construction 110 of the energy accumulation assembly 100 comprises an inner cylinder sleeve 113 disposed inside and an outer cylinder sleeve 112 disposed outside, a cover plate 114 being securely provided at an upper end of the outer cylinder sleeve 112, the cover plate 114 being peripherally hermetically fitted with the upper end of the outer cylinder sleeve 112. The cylinder construction 110 further comprises a cylinder base 115 disposed at a lower end thereof, a lower end of the outer cylinder sleeve 112 being connected to an outer ring 1151 of the cylinder base 115 and maintaining peripherally hermetical fitting therewith, and a lower end of the inner cylinder sleeve 113 being connected to an inner ring 1152 of the cylinder base 115 and maintaining peripherally hermetical fitting therewith; the piston 120 is up-down movably arranged in the inner cylinder sleeve 113, an outer peripheral surface of the piston 120 maintaining peripherally hermetically fitted with an inner wall of the inner cylinder sleeve 113, a rear end of the inner cylinder sleeve 113 being open so that a cavity of the inner cylinder sleeve 113 communicates with a cavity of the outer cylinder sleeve 112. The energy accumulation chamber 111 is enclosed by the outer cylinder sleeve 112, the inner cylinder sleeve 113, the cover plate 114, the cylinder base 115, and the piston 120. A lengthwise direction of the striker 200 is set as the up-down direction, an upper end of the striker 200 being attached to the piston 120 via a structure such as threaded-fitting and/or a pin rod, a lower end of the striker 200 projecting downward out of the cylinder construction 110. In this implementation, the energy accumulation medium 130 is a gas filled in the energy accumulation chamber 111; the upward moving piston 120 shrinks the volume of the energy accumulation chamber 111 so that the gas in the energy accumulation chamber 111 is compressed, which increases the gas pressure, whereby energy is accumulated in the energy accumulation medium. When the striker 200 is released, the piston 120 under the action of the pressurized gas in the energy accumulation chamber 111 drives the striker 200 to move downward towards the bottom dead center (BDC), and with inflation of the volume of the energy accumulation chamber 111, the gas in the energy accumulation chamber 111 expands and the gas pressure decreases. Alternatively, the energy accumulation medium 130 may adopt a conventional energy accumulation spring; in this case, the cylinder construction 110 may be provided with only one cylinder sleeve, the energy accumulation spring being arranged in the cylinder sleeve, an upper end of the energy accumulation spring being positionally retained relative to the cylinder sleeve, a lower end of the energy accumulation spring abutting against the piston 120, so that the piston 120 moving upward compresses the energy accumulation spring to realize energy accumulation, while the energy accumulation spring recovering from deformation applies a force against the piston 120 so that the piston 120 drives the striker 200 to move downward towards the bottom dead center (BDC). Alternatively, the energy accumulation medium 130 may be a combination of the gas and the energy accumulation spring; in this case, the energy accumulation spring is arranged in the inner cylinder sleeve 113, and the gas is filled in the energy accumulation chamber 111, so that the piston 120 moving upward compresses the gas and the energy accumulation spring to realize energy accumulation; the pressurized gas and the energy accumulation spring recovering from deformation may simultaneously apply a force against the piston 120 so that the piston 120 drives the striker 120 to move downward towards the bottom dead center. Alternatively, in a case that the energy accumulation medium 130 only adopts a gas, the cylinder construction 110 may be provided with only one cylinder sleeve if nail driving requirements are met.

In this implementation, a shock absorber 140 positioned at an inner periphery of the cylinder base 115 is provided at the lower end of the cylinder construction 110, a through hole 141 through which the striker 200 passes being provided on the shock absorber 140. When the piston 120 and the striker 200 move downward till the piston 120 contacts the shock absorber 140, the piston 120 and the striker 200 move to the bottom dead center (BDC) where the piston 120 and the striker 200 cannot move further downward. With the shock absorber 140 absorbing the pulsation generated when the piston 120 and the striker 200 move to the bottom dead center (BDC), accompanied pulsation or offset of other members is avoided, which also improves user experience. Exemplarily, to prevent the shock absorber 140 from rotating circumferentially leading to interference with the striking movement of the striker 200, the shock absorber 140 may be set with a non-circular cross-section profile in the direction perpendicular to the up-down direction; correspondingly, an inner hole of the cylinder base 115 is formed of a shape consistent with that of the shock absorber 140. By disposing the shock absorber 140 at the inner periphery of the cylinder base 115 via the non-circular fitting structure, the shock absorber 140 is circumferentially limited.

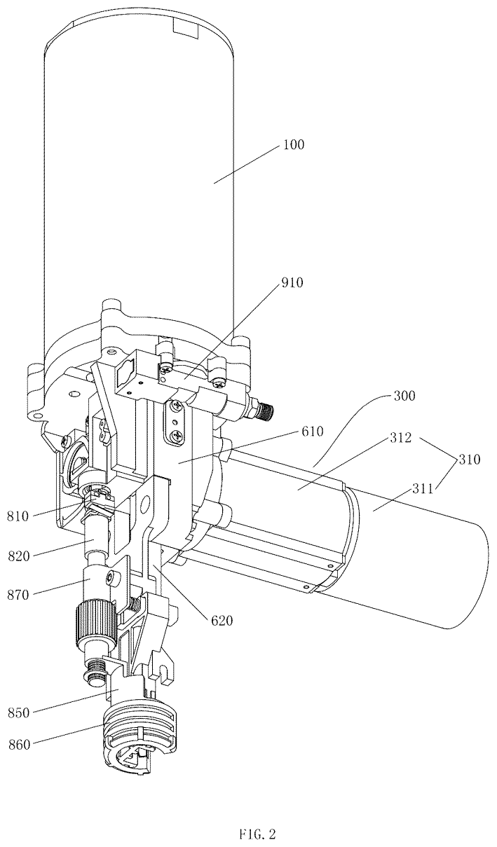

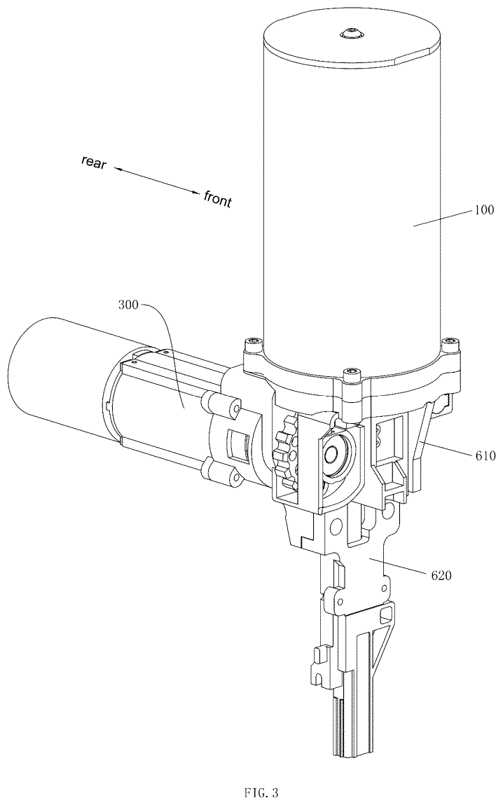

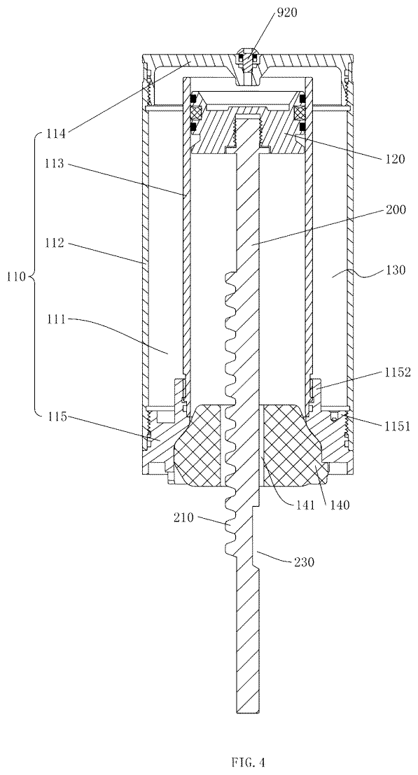

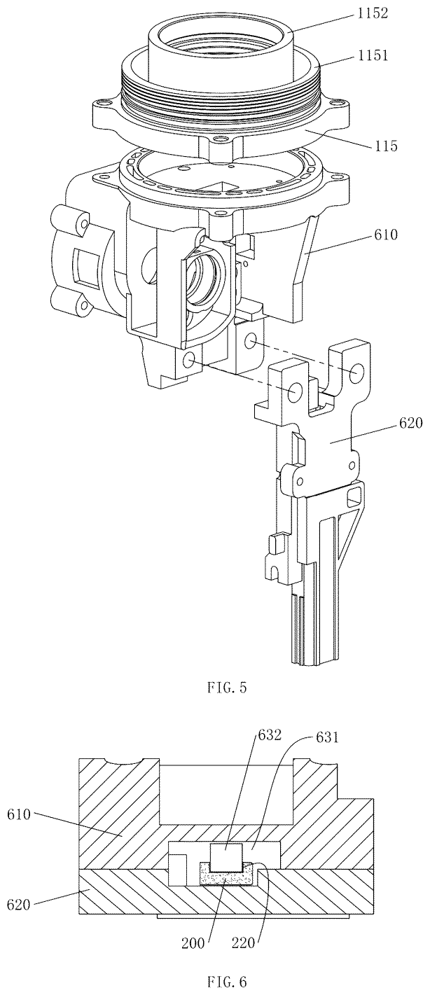

Referring to FIGS. 3 and 5, a stationary support base 610 is provided in the housing 400, the cylinder base 115 being secured to an upper end of the support base 610 so as to secure the cylinder construction 110 on top of the support base 610. A nose-shaped guide seat 620 is securely provided at a lower end of the support base 610, a lower portion of the guide seat 620 projecting downward out of a front portion of the housing 400. Referring to FIG. 6, the support base 610 and the guide seat 620 have an overlap portion in the up-down direction and the overlap portion therebetween forms a segment of guide groove 631 extending in the up-down direction; a guide rib 632 extending in the up-down direction is further provided on the guide seat 620, a lower end of the striker 200 projecting into the guide groove 631, a recess 220 in which the guide rib 632 is inserted being provided at one side of the striker 200 facing the guide rib 632, the guide groove 631 and the guide rib 632 serving to limit up-down movement of the striker 200, so that the striker 200 always moves linearly, which prevents deflection of the striker 200 during movement; otherwise, the nail driving effect would be affected.

Referring to FIG. 7, in this implementation, the striker 200 is provided with a plurality of convex teeth 210 arranged at intervals along a lengthwise direction, and a plurality of transmission teeth 331 arranged at intervals along a peripheral direction are provided on an outer peripheral surface of the drive wheel 330, the transmission teeth 331 meshing with the convex teeth 210. When the drive wheel 330 rotates forwardly about its own central axis along the direction indicated by +ω, the drive wheel 330 drives, via meshing between the transmission teeth 331 and the convex teeth 210, the striker 200 and the piston 120 to move upward, so that the striker 200 and the piston 120 may move upward to return in place. When the striker 200 is driven by the piston 120 to move downward towards the bottom dead center, the downwardly moving striker 200 drives, via meshing between the convex teeth 210 and the transmission teeth 331, the drive wheel 330 to rotate reversely about its own central axis along the direction indicated by −ω. The reverse rotation of the drive wheel 330 prevents the drive wheel 330 from hampering downward movement of the striker 200 so that the striker 200 may be driven by the piston 120 to move towards the bottom dead center. To ensure structural strength of the striker 200, the convex teeth 210 and the striker 200 are exemplarily one-piece formed in this implementation. Alternatively, a toothed bar may be arranged on the striker 200, the convex teeth 210 being provided on the toothed bar.

Referring to FIG. 8, the drive assembly 300 is arranged in the housing 400. In this implementation, the power unit 310 comprises an electric motor 311 and a speed reducer 312, the electric motor 311 having a main shaft 3111, the main shaft 3111 being in transmission connection with a power input end of the speed reducer 312, the output shaft 3121 serving as the power output end of the speed reducer 312. In this implementation, the power unit 310 is positioned below the handle portion 410, the electric motor 311 and the speed reducer 312 being exemplarily co-axially disposed and axially arranged in a front-rear direction, respective axial directions of the electric motor 311 and the speed reducer 312 being perpendicular to a lengthwise direction of the striker 200.

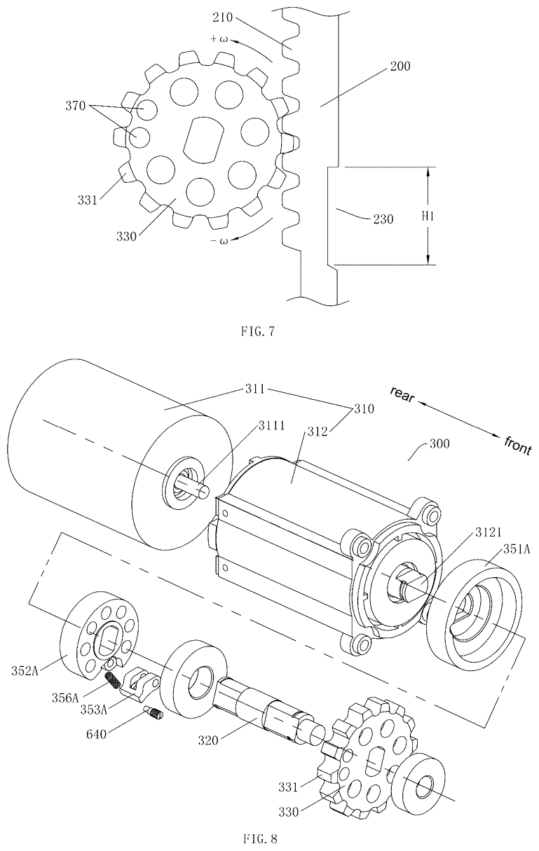

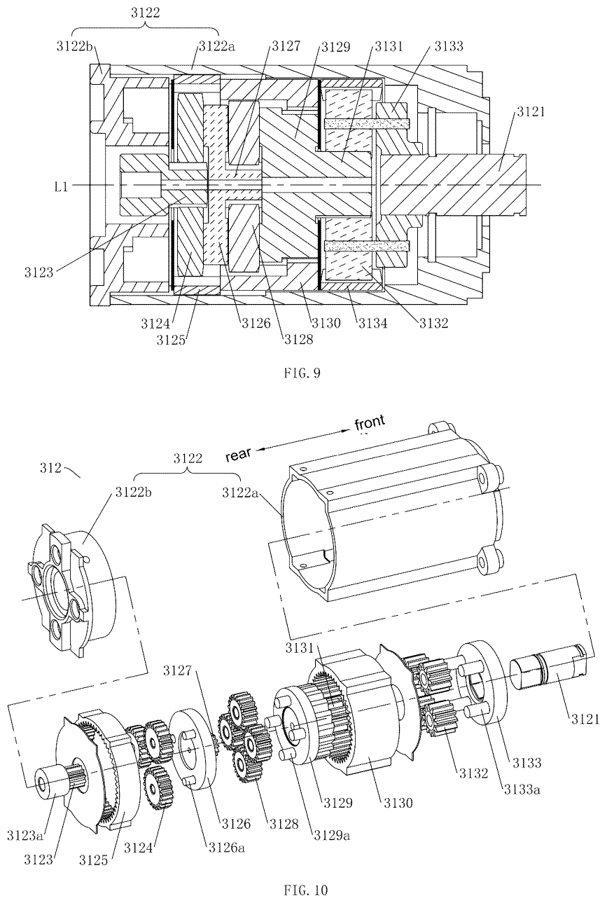

Referring to FIGS. 9 and 10, the speed reducer 312 comprises a casing 3122 and a planetary gear reduction construction arranged in the casing 3122. In this implementation, the speed reducer 312 exemplarily adopts a three-stage planetary gear reduction construction. Specifically, the casing 3122 comprises a main casing body 3122a and a rear cover 3122b disposed at a rear end of the main casing body 3122; the planetary gear reduction construction comprises a first-stage sun gear 3123, a first-stage planetary gear 3124, a first-stage ring gear 3125, a first-stage planetary carrier 3126, a second-stage sun gear 3127, a second-stage planetary gear 3128, a second-stage planetary carrier 3129, a second-stage ring gear 3130, a third-stage sun gear 3131, a third-stage planetary gear 3132, a third-stage planetary carrier 3133, and a third-stage ring gear 3134. A powered joint 3123a is provided at a rear end of the first-stage sun gear 3123, the powered joint 3123a being securely sleeved on the main shaft 3111 of the electric motor 311 so that the first-stage sun gear 3123 may be driven to rotate by the main shaft 3111; a plurality of first-stage planetary gears 3124 are arranged at even intervals along an outer periphery of the first-stage sun gear 3123, each first-stage planetary gear 3124 externally meshing with the first-stage sun gear 3123 and internally meshing with the first-stage ring gear 3125; the first-stage ring gear 3125 is fixed in the main casing body 3122a; first-stage support shafts 3126a corresponding to respective first-stage planetary gears 3124 are provided on the first-stage planetary carrier 3126, the first-stage planetary gears 3124 being disposed on the corresponding first-stage support shaft 3126a, respectively. The second-stage sun gear 3127 and the first-stage planetary carrier 3126 are fixed together or one-piece formed; a plurality of second-stage planetary gears 3128 are arranged at even intervals along an outer periphery of the second-stage sun gear 3127, each second-stage planetary gear 3128 meshing externally with the second-stage sun gear 3127 and meshing internally with the second-stage ring gear 3130; the second-stage ring gear 3130 is fixed in the main casing body 3122a; second-stage support shafts 3129a corresponding to respective second-stage planetary gears 3128 are provided on the second-stage planetary carrier 3129, the second-stage planetary gears 3128 being disposed on the corresponding second-stage support shaft 3129a, respectively. The third-stage sun gear 3131 and the second-stage planetary carrier 3129 are fixed together or one-piece formed, a plurality of third-stage planetary gears 3132 being arranged at even intervals along the outer periphery of the third-stage sun gear 3131, each third-stage planetary gear 3132 externally meshing with the third-stage sun gear 3131 and internally meshing with the third-stage ring gear 3134; the third-stage ring gear 3134 is fixed in the main casing body 3122a; third-stage support shafts 3133a corresponding to respective third-stage planetary gears 3132 are provided on the third-stage planetary carrier 3133, the third-stage planetary gears 3132 being disposed on the corresponding third-stage support shaft 3133a, respectively. The output shaft 3121 is rotatably mounted in the casing 3122 via a bearing, a rear end of the output shaft 3121 being in transmission connection with the third-stage planetary carrier 3133, a front end of the output shaft 3121 projecting forward out of the casing 3122 of the speed reducer 312. The activated electric motor 311 drives the first-stage sun gear 3123 to rotate about a central axis L1 of the speed reducer 312, the rotating first-stage sun gear 3123 driving, via the first-stage planetary gears 3124 and the first-stage planetary carrier 3126, the second-stage sun gear 3127 to rotate about the central axis L1 of the speed reducer 312, the rotating second-stage sun gear 3127 driving, via the second-stage planetary gears 3128 and the second-stage planetary carrier 3129, the third-stage sun gear 3131 to rotate about the central axis L1 of the speed reducer 312, the rotating third-stage sun gear 3131 driving, via the third-stage planetary gears 3132 and the third-stage planetary carrier 3133, the output shaft 3121 to rotate about the central axis L1 of the speed reducer 312, whereby power is outputted. Alternatively, the speed reducer 312 may also adopt another reasonable speed reduction construction such as a two-stage planetary gear reduction construction or four-stage planetary gear reduction construction. Optionally, a non-circular shaft-hole fitting structure or a spline-fitting structure may be adopted to implement transmission connection between the rear end of the output shaft 3121 and the third-stage planetary carrier 3133.

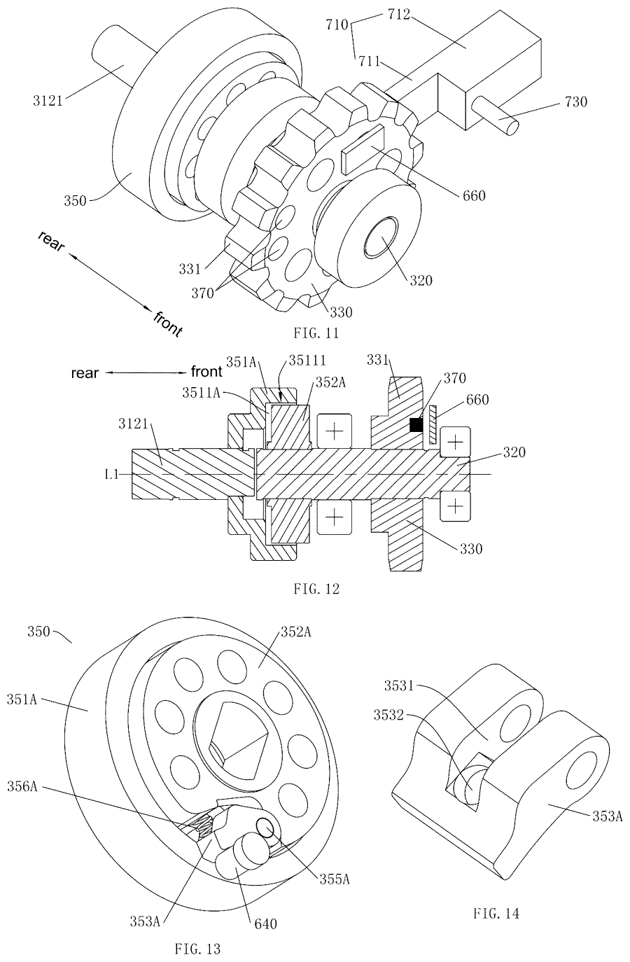

Referring to FIGS. 11 and 12, in this implementation, the drive assembly 300 further comprises a rotary shaft 320, the rotary shaft 320 being rotatably mounted on the support base 610 via a bearing. To simplify the structure of the transmission construction 350, a central axis of the output shaft 3121 and a central axis of the rotary shaft 320 are exemplarily set to coincide, i.e., the central axis of the rotary shaft 320 and the central axis L1 of the speed reducer 312 are exemplarily set to substantially coincide. The transmission construction 350 comprises a master wheel I 351A disposed on the output shaft 3121 and a slave wheel I 352A disposed on the rotary shaft 320. Since the drive wheel 330 is also disposed on the rotary shaft 320, the output shaft 3121, the master wheel I 351A, the slave wheel I 352A, the rotary shaft 320, and the drive wheel 330 rotate about the same central axis L1, so that the radial size of the drive assembly 300 may be reasonably controlled while the transmission-fit between the output shaft 3121 and the rotary shaft 320 can be eased.

Referring to FIG. 13, a movable transmission ratchet tooth 353A is provided for one of the master wheel I 351A and the slave wheel I 352A, while a transmission ratchet slot 354A is provided for the other one of the master wheel I 351A and the slave wheel I 352A; when the transmission ratchet tooth 353A is inserted in the transmission ratchet slot 354A, the master wheel I 351A and the slave wheel I 352A are in an engaged state; when the transmission ratchet tooth 353A migrates out of the transmission ratchet slot 354A, the master wheel I 351A and the slave wheel 352A are in a disengaged state. Specifically in this implementation, the master wheel I 351A is disposed at the front end of the output shaft 3121 via a non-circular shaft-hole fitting structure, and the slave wheel I 352A is disposed at the rear end of the rotary shaft 320 via a non-circular shaft-hole fitting structure. Referring to FIG. 15, an inwardly recessed concave 3511A is provided at a front side of the master wheel I 351A, the slave wheel I 352A being accommodated in the concave 3511A. The transmission ratchet tooth 353A is pivotally arranged at an outer edge of the slave wheel I 352A via a pin 355A; the transmission ratchet slot 354A is disposed on an inner wall 35111 of the concave 3511A, a first slot wall 3541A joining the inner wall 35111 being arranged at an arched end of the transmission ratchet slot 354A, a second slot wall 3542A joining the inner wall 35111 being arranged at an opposite arched end of the transmission ratchet slot 354A, a slope of the first slot wall 3541A relative to the inner wall 35111 being greater than a slope of the second slot wall 3542A relative to the inner wall 35111. Referring to FIG. 16, a cut-out 3521 configured to dispose the transmission ratchet tooth 353A is provided at an outer edge of the slave wheel I 352A, and a lug 3522 arranged substantially at an axially midpoint relative to the slave wheel I 352A is provided at the cut-out 3521. Referring to FIG. 14, a notch 3531 configured to avoid the lug 3522 is defined at an intermediate position of the transmission ratchet tooth 353A in the thickness direction, the lug 3522 being inserted in the notch 3531, the pin 355A passing through holes on the lug 3522 and the transmission ratchet tooth 353A so that the transmission ratchet tooth 353A is hinged to the slave wheel I 352A; the transmission ratchet tooth 353A may pivot towards the center of the slave wheel I 352A or pivot away from the center of the slave wheel I 352A. Alternatively, the transmission ratchet tooth may be slidably arranged at an outer edge of the slave wheel I, so that the transmission ratchet tooth may slide towards the center of the slave wheel I or may slide away from the center of the slave wheel I.

A locating rod 640 that is positionally retained is provided on the support base 610, the transmission ratchet tooth 353A abutting against the locating rod 640 is forced to migrate out of the transmission ratchet slot 354A. To ensure that the transmission construction 350 may switch smoothly between the transmission engaged state and the disengaged state, the transmission construction 350 further comprises a transmission spring 356A biasing the transmission ratchet tooth 353A towards the transmission ratchet slot 354A; when the transmission ratchet tooth 353A is forced to migrate out of the transmission ratchet slot 354A, the transmission spring 356A is deformed under stress; when the transmission ratchet tooth 353A is released, the transmission spring 356A recovers from deformation and forces the transmission ratchet tooth 353A to abut towards the transmission ratchet slot 354A. In this implementation, a locating slot 3532 is provided at one side of the transmission ratchet tooth 353A facing the master wheel I 351A, one end of the transmission spring 356A abutting against a side wall of the cut-out 3521 so as to be positionally retained, an opposite end of the transmission spring 356A being inserted in the locating slot 3532 so as to contact the transmission ratchet tooth 353A. When the transmission ratchet tooth 353A is abutted against by the locating rod 640 to migrate out of the transmission ratchet slot 354A while the transmission spring 356A is compressed under stress, the transmission construction 350 is in the disengaged state so that the slave wheel I 352A may rotate reversely relative to the master wheel I 351A, i.e., the slave wheel I 352A, the rotary shaft 320, and the drive wheel 330 may rotate reversely relative to the master wheel I 351A and the output shaft 3121, which prevents the drive wheel 330 from hampering movement of the striker 200. When the slave wheel I 352A and the master wheel I 351A rotate in opposite directions till the transmission ratchet tooth 353A is re-aligned with the transmission ratchet slot 354A, the transmission spring 356A recovering from deformation biases the transmission ratchet tooth 353A towards the transmission ratchet slot 354A, so that the transmission ratchet tooth 353A is re-fitted with the transmission ratchet slot 354A, resulting in that the transmission construction 350 resumes the engaged state, whereby the output shaft 3121 may drive, via the transmission construction 350, the rotary shaft 320 and the drive wheel 330 to rotate forwardly; as such, the forwardly rotating drive wheel 330 may drive the striker 200 to move upward to return in place. Alternatively, a locating stud may also be provided at one side of the transmission ratchet tooth 353A facing the master wheel I 351A, an opposite end of the transmission spring 356A being disposed on the locating stud to contact the transmission ratchet tooth 353A.

Referring to FIG. 17, the fastener driving tool according to this implementation may further comprise a latch 710 having a locked state and an unlocked state, the latch 710 in the locked state being fitted with the striker 200 to lock the striker 200, the latch 710 in the unlocked state releases the striker 200 so that the striker 200 may be driven by the piston 120 to move towards the bottom dead center. The latch 710 in the locked state locks the striker 200, preventing the striker 200 from being accidentally driven by the piston 120 to move towards the bottom dead center, which ensures use safety of the tool.

Referring to FIG. 17, to facilitate the latch 710 to release the striker 200, in this implementation, the drive assembly 300 further comprises an unlocking member 360 rotating with the output shaft 3121 or with the drive wheel 330, the unlocking member 360 being operable to drive the latch 710 to switch from the locked state to the unlocked state so as to release the striker 200. To facilitate the unlocking member 360 to switch the latch 710 to the unlocked state, the latch 710 is exemplarily left-right slidably disposed on the support base 610, so that a sliding direction of the latch 710 is perpendicular to the axial direction of the drive assembly 300. Specifically in this implementation, the unlocking member 360 rotates with the rotary shaft 320, and the unlocking member 360 and the drive wheel 330 are exemplarily one-piece formed or separately formed and then fixed together. The rotational centerline of the unlocking member 360 substantially coincides with the central axis L1 of the speed reducer 312. The unlocking member 360 is of a cam structure. An outer peripheral surface of the unlocking member 360 comprises an arc-shaped surface 361 and an avoidance surface 362 disposed between two ends of the arc-shaped surface 361, the center of the arc-shaped surface 361 being located on the central axis L1, the arc-shaped surface 361 having a radius R, the avoidance surface 362 being substantially planar with its two ends flatly joined with the two ends of the arc-shaped surface 361, a distance between the avoidance surface 362 and the central axis L1 being less than R. The abutment between the arc-shaped surface 361 and the latch 710 allows for the rotating unlocking member 360 to switch and retain the latch 710 to the unlocked state, and the avoidance surface 362 allows for the rotating unlocking member 360 to release the latch 710 so that the latch 710 may return to the locked state. As a feasible solution of this implementation, the avoidance surface 362 may be a beveled surface parallel to the central axis L1 or a curved structure bent towards the central axis L1 such as an inwardly recessed curved surface or an S-shaped curved surface.

Referring to FIG. 18, to allow for the latch 710 released by the unlocking member 360 to smoothly return to the locked state, the fastener driving tool further comprises a locking spring 720 biasing the latch 710 towards the striker 200, the locking spring 720 being configured to be deformed under stress when the latch 710 switches from the locked state to the unlocked state and when the striker 200 returns in place, drive the latch 710 released by the unlocking member 360 to return to the locked state from the unlocked state. The latch 710 comprises a linkage portion 711 proximal to the unlocking member 360 and a locking portion 712 distal from the unlocking member 360, a thickness of the linkage portion 711 being less than a thickness of the locking portion 712. The unlocking member 360 is disposed at a rear side of the drive wheel 330, and the locking portion 712 is correspondingly disposed at a rear side of the striker 200. One end of the locking spring 720 is positionally retained, and an opposite end of the locking spring 720 is inserted in a hole on the latch 710 so as to contact the latch 710. The locking spring 720 is in a compressed state to dispose the latch 710 abutting towards the unlocking member 360. A locking slot 230 in which the locking portion 712 is inserted is provided at one side of the striker 200 facing the locking portion 712. When the striker 200 returns in place, the prestress force of the locking spring 720 acts on the latch 710 so that the linkage portion 711 abuts against an outer peripheral surface of the unlocking member 360 and the locking portion 712 is inserted in the locking slot 230 of the striker 200, whereby the locking portion 712 is fitted with the locking slot 230 to lock the striker 200. To drive a nail, the unlocking member 360 rotating with the drive wheel 330 disposes the arc-shaped surface 361 abutting against the linkage portion 711 of the latch 710, pushing the latch 710 to slide in a direction away from the central axis L1 so that the locking member 712 migrates out of the locking slot 230, whereby the striker 200 is released by the latch 710, and the released striker 200 may be driven by the piston 120 to move towards the bottom dead center. During the fastener driving process, the linkage portion 711 of the latch 710 abuts against the arc-shaped surface 361 so that the latch 710 substantially does not contact the striker 200 when the striker 200 is moving towards the bottom dead center, which prevents the latch 710 from interfering with movement of the striker 200. When the striker 200 is driven by the drive wheel 330 to move upward to be about to return in place, the linkage portion 711 of the latch 710 is disengaged from the arc-shaped surface 361 to abut against the avoidance surface 362; since the distance between the avoidance surface 362 and the central axis L1 is less than the radius R of the arc-shaped surface 361, the unlocking member 360 releases the latch 710, so that the locking spring 720 recovering from deformation may drive the latch 710 released by the unlocking member 360 to slide towards the unlocking member 360. When the striker 200 returns in place, the locking portion 712 of the latch 710 is inserted in the locking slot 230, and the latch 710 returns to the locked state to lock the striker 200. Alternatively, the unlocking member 360 may be separately provided; the separate unlocking member 360 may be disposed on the rotary shaft 320 to rotate with the rotary shaft 320, which may also be disposed on the output shaft 3121 to rotate with the output shaft 3121. Exemplarily, height H1 of the locking slot 230 in the up-down direction is slightly greater than height H2 of the latch 710 in the up-down direction.

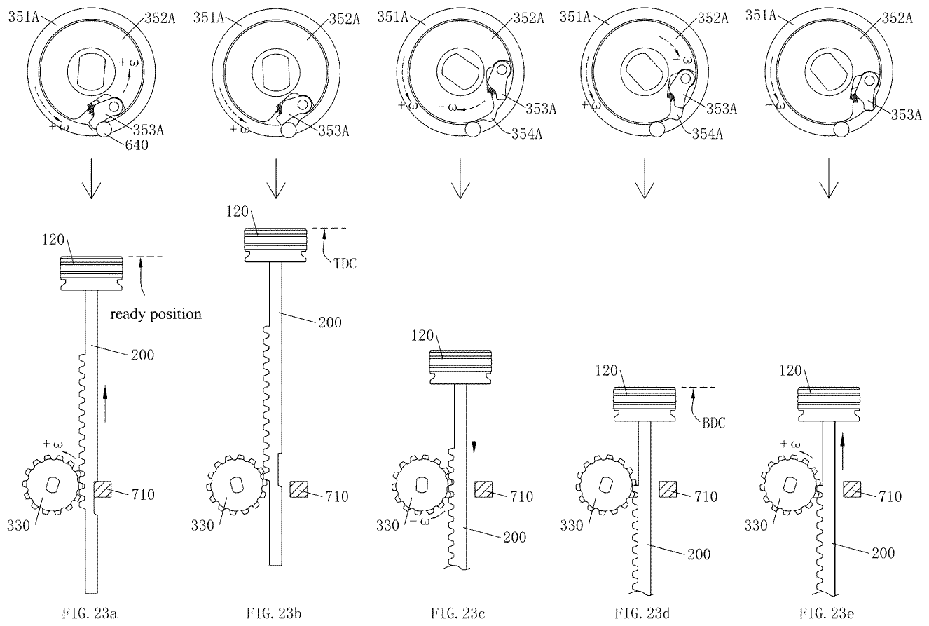

Referring to FIGS. 23a-23e, in this implementation, the striker 200 has a ready position (RP) where it is locked by the latch 710, the latch being positioned between the top dead center (TDC) and the bottom dead center (BDC), i.e., the ready position is lower than the top dead center (TDC). Specifically, the number of transmission teeth 331 in the peripheral direction of the drive wheel 330 is slightly greater than the number of convex teeth 210 on the striker 200; when the striker 200 is disposed at the ready position indicated in FIG. 23a, the one or two convex teeth 210 at the lowermost end have not meshed with the drive wheel 330 yet and the transmission ratchet tooth 353A has not migrated out of the transmission ratchet slot 354A either; when the tool performs a driving job, the drive wheel 330 is first actuated by the power unit 310 to rotate forwardly, and the forwardly rotating drive wheel 330 drives the striker 200 and the piston to move upward from the ready position indicated in FIG. 23a to the top dead center (TDC) indicated in FIG. 23b; meanwhile, the unlocking member 360 rotating forwardly in synchronization with the drive wheel 330 switches the latch 710 from the locked state to the unlocked state via abutment between the arc-shaped surface 361 and the latch 710, and the latch 710 switched to the unlocked state migrates out of the locking slot 230, whereby the latch 710 releases the striker 200. When the forwardly rotating drive wheel 330 drives the striker 200 to move upward till the transmission tooth 331 on the drive wheel 330 is about to migrate from the convex tooth 210 at the lowermost end of the striker 200, the striker 200 moves to the top dead center (TDC); now, under the abutment action of the locating rod 640, the transmission ratchet tooth 353A overcomes a biasing force imposed by the transmission spring 356A to deflect towards the center of the slave wheel I 352A so as to migrate out of the transmission ratchet slot 354A; the transmission ratchet tooth 353A migrating out of the transmission ratchet slot 354A abuts against the inner wall 35111 of the concave 3511A, whereby the transmission construction 350 switches from the engaged state to the disengaged state. Afterwards, the compressed gas in the energy accumulation chamber 111 expands to apply a force against the piston 120, so that the piston 120 drives the striker 200 to move downward from the top dead center (TDC) to the bottom dead center (BDC). During downward movement of the piston 120 and the striker 200, the downward movement speed of the striker 200 is far higher than the return speed of the latch 710 driven by the locking spring 720, so that when the striker 200 moves downward till the locking slot 230 is disposed below the latch 710, the latch 710 has not returned to the locked state yet despite the acting force of the locking spring 720, which thereby prevents the latch 710 from being inserted into the locking slot 230 during downward movement of the striker 200 affecting the striking movement of the striker 200. Referring to FIG. 23c, during the process of the piston 120 and the striker 200 moving towards the bottom dead center (BDC), the downward moving striker 200 drives the drive wheel 330 to rotate reversely in the direction indicated by −ω, and the drive wheel 330 drives the rotary shaft 320 and the slave wheel I 352A to synchronously rotate reversely and drives the slave wheel I 352A and the master wheel I 351A to rotate in opposite directions, so that the transmission ratchet tooth 353A abuts against the inner wall 35111 of the concave 3511A and moves relative to the inner wall 35111; during this process, the latch 710 abuts against the arc-shaped surface 361 and is retained in the unlocked state. When the piston 120 and the striker 200 move downward till the piston 120 contacts the shock absorber 140, the piston 120 and the striker 200 move to the bottom dead center (BDC) indicated in FIG. 23d; now, the transmission tooth 331 on the drive wheel 330 meshes with the convex tooth 210 at the uppermost end of the striker 200, and the transmission ratchet tooth 353A is about to re-align with the transmission ratchet slot 354A. Referring to FIG. 23e, when the master wheel I 351A rotates forwardly till the transmission ratchet slot 354A is re-aligned with the transmission ratchet tooth 353A, the transmission spring 356 recovering from deformation drives the transmission ratchet tooth 353A which has migrated from the inner wall 35111 to be re-inserted into the transmission ratchet slot 354A so that the transmission construction 350 resumes the engaged state; then, the forwardly rotating master wheel I 351A drives, via fitting between the transmission ratchet slot 354A and the transmission ratchet tooth 353A, the slave wheel I 352A to synchronously rotate forwardly, the slave wheel I 352A drives, via the rotary shaft 320, the drive wheel 330 to synchronously rotate forwardly, and the forwardly rotating drive wheel 330 drives, via meshing between the transmission tooth 331 and the convex tooth 210, the striker 200 and the piston 120 to move upward to return in place. Referring to FIG. 23a, when the striker 200 and the piston 120 move upward till the locking slot 230 is aligned with the latch 710, the locking spring 720 recovering from deformation drives the latch 710 to return to the locked state from the unlocked state, and the locking portion 712 of the latch 710 is inserted in the locking slot 230 so as to lock the striker 200 to its ready position, whereby a fastener driving cycle is completed. To ensure a driving force against the fastener, the striker 200 may contact the to-be-driven fastener before or at the instant of moving to the bottom dead center (BDC).

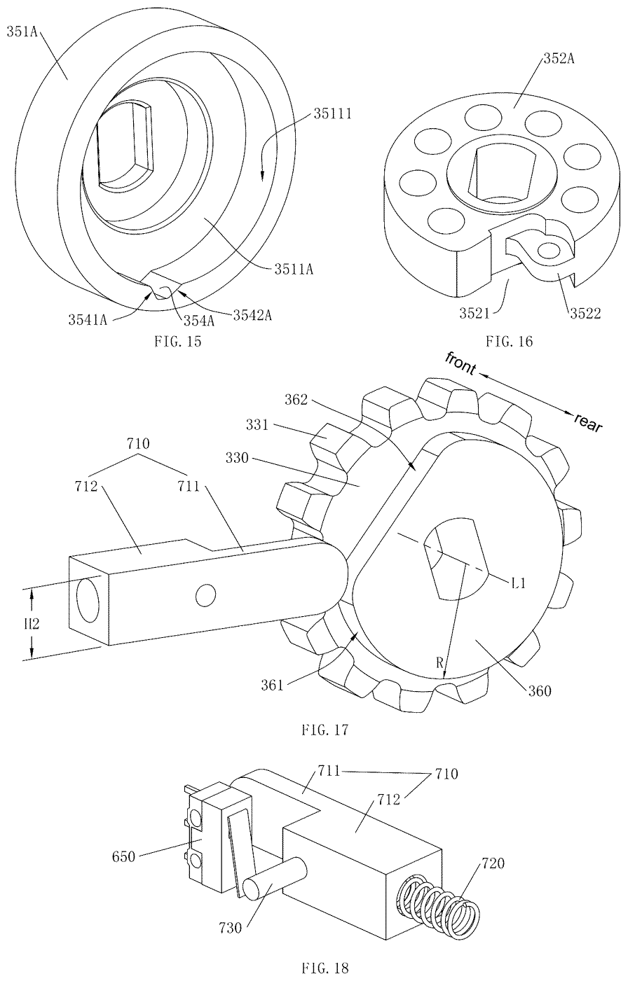

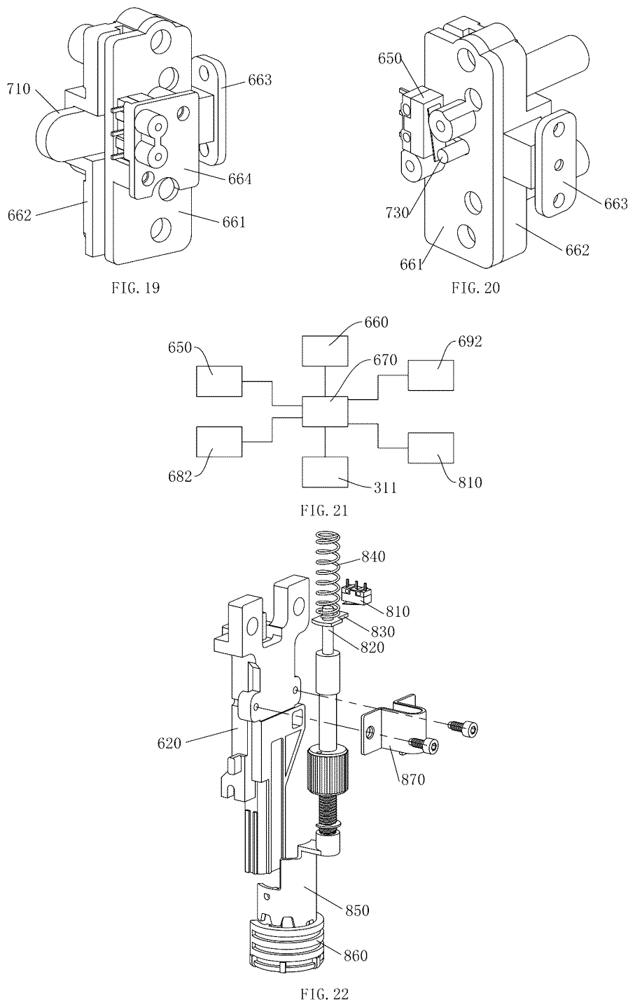

Referring to FIGS. 19 and 20, a first rest plate 661 and a second rest plate 662 configured to mount the latch 710 are securely provided on the support base 610, the first rest plate 661 and the second rest plate 662 being fitted to form a groove in which the latch 710 slides, the latch 710 being disposed between the first rest plate 661 and the second rest plate 662 and partially inserted in the groove. The support base 610 is securely provided with a third rest plate 663 at one side of the latch 710 facing away from the striker 200, one end of the locking spring 720 abutting against the third rest plate 663 so as to be positionally retained.

The fastener driving tool further comprises a locking switch 650 that is positionally retained, the locking switch 650 being triggered when the latch 710 returns to the locked state. Specifically, the locking switch 650 may adopt a microswitch, the locking switch 650 being secured on the first rest plate 661 via a fourth rest plate 664; a push rod 730 configured to trigger the locking switch 650 is provided on the latch 710, the push rod 730 pressing an elastic plate of the microswitch so that the microswitch is triggered. When the latch 710 moves from the locked state to the unlocked state, the push rod 730 releases the locking switch 650 so that on/off state of the locking switch 650 changes. When the latch 710 returns to the locked state from the unlocked state, the push rod 730 triggers the locking switch 650 so that the on/off state of the locking switch 650 changes again; change of the on/off state of the locking switch 650 serves to determine whether the latch 710 has returned to the locked state, thereby determining whether the striker 200 has returned to the ready position. Alternatively, the locking switch 650 may also adopt a non-contact switch such as a magnetic switch or a photoelectric switch; if the locking switch 650 adopts a magnetic switch, a magnet configured to trigger the magnetic switch may be provided on the latch 710.

Referring to FIGS. 11 and 12, the fastener driving tool further comprises a magnetic sensor 660 that is positionally retained, and a magnet 370 configured to trigger the magnetic sensor 660 is provided on the drive wheel 330, so that the power unit 310 decelerates or brakes in advance based on a signal of the magnetic sensor 660 being triggered by the magnet 370. Specifically, the magnetic sensor 660 may adopt a sensing element which may output different electric signals dependent on magnetic field intensity change, such as a Hall element, a dry-reed switch, etc. The magnetic sensor 660 is secured on the support base 610 via a holder; certain spacing is left between the magnetic sensor 660 and the drive wheel 330 to prevent interference with rotation of the drive wheel 330; the magnet 370 is fully embedded in the drive wheel 330. As an alternative, the magnet 370 may also be provided on the striker 200.

Referring to FIG. 21, the fastener driving tool according to this implementation further comprises a control 670 provided in the housing 400, the electric motor 311 being controlled by the control 670, the locking switch 650 and the magnetic sensor 660 being electrically connected to and/or communicating with the control 670. The control 670 determines whether the striker 200 is located at the ready position based on a signal fed back from the locking switch 650 and determines whether the striker 200 is about to return to the ready position based on a signal fed back from the magnetic sensor 660. Referring to FIG. 1, a trigger 681 operable to activate the tool is provided on the handle portion 410 of the housing 400, and a start/stop switch 682, which corresponds to the trigger 681 and is electrically connected to and/or communicates with the control 670, is provided in the housing 400, the trigger 681 being pressed to trigger the start/stop 682; the trigger 681 when being released releases the start/stop switch 682; and the control 670 activates or deactivates the tool based on a signal fed back from the start/stop switch 682. To better satisfy user needs, a push block 691 operable to select a nail driving mode is further provided on the housing 400, and a mode toggle switch 692, which corresponds to the push block 691 and is electrically connected to and/or communicates with the control 670, is provided in the housing 400, so that the user may select a single-shot nail driving mode or a continuous nail driving mode via the push block 691.

In this implementation, when the forwardly rotating drive wheel 330 drives the striker 200 to move upwards till the magnetic sensor 660 is triggered by the magnet 370, it indicates that the striker 200 is about to return to the ready position; now, the control 670 instructs the electric motor 311 to decelerate based on a trigger signal emitted by the magnetic sensor 660. When the locking switch 650 is triggered by the push rod 730, it indicates that the striker 200 has returned to the ready position; now, the control 670 instructs the electric motor 311 to brake based on a trigger signal from the locking switch 650, whereby the drive wheel 330 stops forward rotation. By triggering the magnetic sensor 660 and the locking switch 650 in sequence so that the electric motor 311 first decelerates before braking when one fastener driving cycle is about to end, the electric motor 311 may brake more easily, which ensures operating performance and stability of the electric motor 311. Optionally, when the control 670 instructs the electric motor 311 to decelerate based on a trigger signal from the magnetic sensor 660, the electric motor 311 may decrease the speed by any value in a range from 50% to 80%.

Alternatively, the locking switch 650 may be canceled while only retaining the magnetic sensor 660; when the magnetic sensor 660 is triggered by the magnet 370, it indicates that the striker 200 has resumed the ready position, and the control 670 instructs the electric motor 311 to brake based on the trigger signal from the magnetic sensor 660. Alternatively, the magnetic sensor 660 may be canceled while retaining the locking switch 650; when the locking switch 650 is triggered, it indicates that the striker 200 has resumed the ready position, and the control 670 instructs the electric motor 311 to brake based on the trigger signal from the locking switch 650.

Referring to FIGS. 2 and 22, to ensure operating safety, a safety construction is provided on the guide seat 620. Specifically, the safety construction comprises a safety switch 810, an ejection rod 820, a pressing piece 830, a safety spring 840, an ejection rack 850, and an elastic sleeve 860. The safety switch 810 is secured on the guide seat 620 or the support base 610; the safety switch 810 is electrically connected to and/or communicates with the control 670. In this implementation, the safety switch 810 adopts a microswitch. The ejection rod 820 is up-down movably mounted on the guide seat 620 via a clasp 870, movement travel of the ejection rod 820 being limited by the clasp 870. The pressing piece 830 is arranged on the ejection rod 820 and configured to trigger the safety switch 810. The safety spring 840 is disposed in a compressed state, an upper end thereof being positionally retained, a lower end thereof abutting against the pressing piece 830; the safety spring 840 forces the ejection rod 820 to abut downwardly; the ejection rack 850 is attached to a lower end of the ejection rod 820; and the elastic sleeve 860 sleeves a lower end of the ejection rack 850. In a normal state, the safety spring 840 forces the ejection rod 820 to abut downwardly so that the pressing piece 830 releases the safety switch 810, disposing the safety switch 810 in an untriggered state, whereby the control 670 does not activate the tool. When the user holds the tool with the elastic sleeve 860 tightly pressed against the workpiece, the elastic sleeve 860 drives, via the ejection rack 850, the ejection rod 820 to overcome the prestress force of the safety spring 840 to move upward with the safety spring 840 being compressed under stress, the pressing piece 830 moving upward with the ejection rod 820 triggers the safety switch 810, the control 670 determines that the tool is ready for fastener driving based on the trigger signal from the safety switch 810, and after the trigger 681 is pressed, the control 670 instructs the electric motor 311 to operate. When the elastic sleeve 860 is released, the safety spring 840 recovering from deformation drives the ejection rod 820, the ejection rack 850, and the elastic sleeve 860 to move downward to return in place, and the pressing piece 830 releases the safety switch 810, whereby the safety switch 810 resumes the untriggered state. Alternatively, the safety switch 710 may also adopt an existing non-contact switch such as a magnetic switch, a photoelectric switch, or a proximity switch; the upward moving ejection rod 820 may vary the electric signal outputted by the safety switch 810, so that the control 670 determines that the tool is ready for fastener driving based on electric signal change of the safety switch 810.

To enable the tool to adjust nail driving depth, in this implementation, the ejection rack 850 is threaded-fitted to the lower end of the ejection rod 820; in a need of adjusting the nail driving depth, a force is applied against the ejection rod 820 so that the ejection rod 820 rotates about its own central axis; the ejection rod 820 when rotating changes its own up-down position relative to the ejection rack 850, so that the up-down movement travel of the ejection rod 820 changes relative to the clasp 870, which further leads to change of the up-down movement travel of the ejection rack 850, whereby nail driving depth is adjusted.

Alternatively, the safety switch assembly in this implementation may adopt the one disclosed in conventional technologies such as CN109623737B, U.S. Pat. No. 11,478,912B2, and EP3670093A1, which will not be detailed here.

Referring to FIG. 1, the fastener driving tool according to this implementation further comprises a feeder assembly 500 configured to supply a to-be-driven fastener, a front end of the feeder assembly 500 being detachably connected to the guide seat 620 via a snap-fit structure, a rear end of the feeder assembly 500 being detachably connected to a rear end of the housing 400 via a snap-fit structure. The feeder assembly 500 comprises a guide rail 510 and a push block 520, the guide rail 510 being provided with an accommodation groove configured to load fasteners, the push block 520 being front-rear movably disposed on the guide rail 510, the push block 520 biasing the fasteners in the accommodation groove forwardly under the action of a tension spring or another elastic element so that the fasteners in the accommodation groove can be automatically fed to a to-be-driven position. The to-be-driven fasteners may be straight nails, staples, or the like. The tools may be configured with a plurality of feeder assemblies 500 based on the types, models, or serial arrangement manners of the fasteners. Other structures of the feeder assembly 500 may refer to those disclosed in conventional technologies such as CN109623737B, U.S. Pat. No. 11,478,912B2, and EP3670093A1.

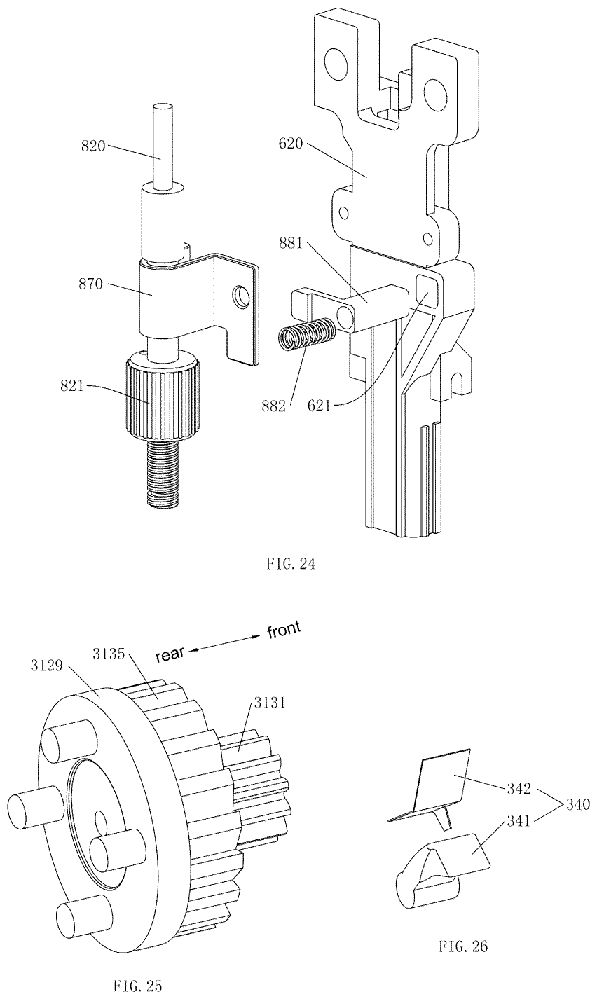

Referring to FIG. 24, to prevent dry firing, a stopper 881 for limiting the ejection rod 820 is provided on the guide seat 620, the stopper 881 being operable to trigger the safety switch 810 when the number of to-be-driven fasteners decreases to an alarm number. In this implementation, the stopper 881 is partially inserted in a mounting hole 621 on the guide seat 620, the stopper 881 being front-rear movable relative to the guide seat 620; a biasing spring 882 is arranged between the clasp 870 and the stopper 881, the biasing spring 882 being in a compressed state, one end of the biasing spring 882 abutting against the clasp 870 so as to be positionally retained, an opposite end thereof abutting against the stopper 881; the biasing spring 882 forces the stopper 881 to abut rearwardly; and a pressing plate 530 configured to press the stopper 881 to abut forwardly is provided on the push block 520 of the feeder assembly 500. When the count of fasteners in the feeder assembly 500 decreases till an alarm count, the push block 520 moving to the front end of the guide rail 510 forces the pressing plate 530 to abut against the stopper 881 so that the stopper 881 overcomes the prestress force of the biasing spring 882 to move forward to further compress the biasing spring 882, the forward moving stopper 881 being partially stuck between the clasp 870 and a thickened portion 821 of the ejection rod 820; now, if the elastic sleeve 860 is forced to abut against the workpiece, due to being stopped by the stopper 881, the ejection rack 850 being abutted against by the workpiece cannot drive the ejection rod 820 to move upward to trigger the safety switch 810, so that the tool cannot be activated, whereby the user is alarmed to load fasteners. As a feasible solution of this implementation, when the count of fasteners decreases to 0 or 1 or 2 or 3, the stopper 881 is partially stuck between the clasp 870 and the thickened portion 821 of the ejection rod 820 to block the ejection rod 820 from triggering the safety switch 810.

When the tool is idle, the latch 710 is in the locked state to lock the striker 200 and the piston 120 to the ready position, the gas, i.e., the energy accumulation medium 130, in the energy accumulation chamber 111 is in a compressed state, and the transmission ratchet tooth 353A is inserted in the transmission ratchet slot 354A so that the transmission construction 350 is disposed in the engaged state. After the tool is activated, the movement states of the striker 200, the drive wheel 330, and the transmission construction 350 may refer to the description supra and FIGS. 23a˜23e.

When the drive wheel 330 rotates forwardly till the magnetic sensor 660 is triggered by the magnet 370, the electric motor 311 decelerates; now, the striker 200 is about to move upward till the locking slot 230 is aligned with the latch 710, the latch 710 migrates from the arc-shaped surface 361 of the unlocking member 360 and is aligned with the avoidance surface 362, the locking spring 720 recovering from deformation drives the latch 710 released by the unlocking member 360 to slide towards the unlocking member 360 so that the latch 710 returns to the locked state from the unlocked state, the latch 710 resuming the locked state disposes the locking portion 712 inserted in the locking groove 230 of the striker 200, and the latch 710 fitted with the locking slot 230 locks the striker 200 to the ready position. When the latch 710 resumes the locked state, the push rod 730 triggers the locking switch 650, and the control 670 determines that the striker 200 has resumed the ready position based on the trigger signal from the locking switch 650, whereby the electric motor 311 is braked.

If the striker 200 is jammed during the process of returning to the top dead center (TDC), the drive load of the electric motor 311 increases, so does the current of the electric motor 311; in this case, the control 670 may instruct the electric motor 311 to halt.

If the push rod 730 fails to trigger the locking switch 650 upon halt of the electric motor 311, the control 670 determines that the striker 200 does not return to the top dead center (TDC) in place at the end of the last nail driving cycle; therefore, when starting a next nail driving cycle, the control 670 first instructs the electric motor 311 to drive the striker 200 to return to the top dead center (TDC) before executing the next nail driving cycle.

Referring to FIGS. 2 and 4, to allow for the gas as the energy accumulation medium to satisfy the nail driving requirements, an inflation valve 910 configured to recharge gas into the energy accumulation chamber 111 is provided on the support base 610; after the tool has served over a certain period, gas may be recharged via the inflation valve 910 to ensure the driving force applied by the striker 200 against the fastener. A vent valve 920 configured to release pressure of the energy accumulation chamber 111 is provided on the cover plate 114; the gas pressure in the energy accumulation chamber 111 may be adjusted via combination of the vent valve 920 and the inflation valve 910 before the tool leaves the factory. If the gas pressure in the energy accumulation chamber 111 is too high due to a high ambient temperature during subsequent use, the gas pressure in the energy accumulation chamber 111 may also be adjusted via the vent valve 920.

To facilitate hanging the fastener driving tool according to this implementation, a rotatable hook may be arranged on the housing 400, so that the user may hang the tool on a bar via the hook; if the tool is not hung, the hook may be rotated to fit snug with the housing 400. In addition, to facilitate the user to carry the tool, strap buckles may be arranged at front-rear ends of the housing 400, a strap being detachably connected to the strap buckles so that the user may carry the tool via the strap.

Alternatively, the drive wheel 330 may also adopt another structure, e.g., a plurality of transmission pins arranged at intervals along the peripheral direction may be arranged on a front end surface of the drive wheel 330, so that the forwardly rotating drive wheel 330 drives the striker 200 upward to return to the top dead center (TDC) via fitting between the transmission pins and the convex teeth 210; or, the drive wheel 330 comprises two disc bodies arranged oppositely with an interval and transmission pins arranged between the two disc bodies; the plurality of transmission pins being distributed at intervals along the peripheral direction of the drive wheel 330, two ends of each transmission pin being securely inserted into the two disc bodies, so that the forwardly rotating drive wheel 330 drives the striker 200 to move upward to the top dead center (TDC) via fitting between the transmission pins and the convex teeth 210.

### Second Implementation

Referring to FIGS. 25 through 27, in this implementation, a limiting construction 340 configured to prevent reverse rotation of the output shaft is provided in the speed reducer. Specifically, the structure of the speed reducer is substantially identical to that described in the first implementation, except that a ratchet 3135 rotating synchronously with the second-stage planetary carrier 3129 and the third-stage sun gear 3131 is arranged therebetween; the limiting construction 340 comprises a limiting ratchet tooth 341 arranged on an inner wall of the second-stage ring gear 3130 and an elastic plate 342 biasing the limiting ratchet tooth 341 towards the ratchet 3135, a plurality of limiting ratchet teeth 341 being distributed at intervals along the peripheral direction of the second-stage ring gear 3130, the limiting rachet teeth 341 being hinged to an inner side of the second-stage gear ring 3130; the elastic plate 342 is substantially of a V shape, the elastic plate 342 being disposed between the second-stage ring gear 3130 and the limiting ratchet teeth 341, the elastic plate 342 being operable to bias the limiting ratchet teeth 341 towards the ratchet 3135; due to fitting between the limiting ratchet teeth 341 and the ratchet 3135, the ratchet 3135 can only rotate unidirectionally, so that the third-stage planetary carrier and the output shaft also can only rotate unidirectionally.

With the limiting construction 340, the output shaft can only rotate unidirectionally, rotation of which in the opposite direction is disabled; when the transmission construction is still in the engaged state, rotation of the drive wheel and the rotary shaft in the opposite direction is also disabled; since the drive wheel cannot rotate in the opposite direction, the striker cannot move downward toward the bottom dead center, i.e., the striker is also locked, and the striker can be thusly locked at any position between the TDC and the bottom dead center (BDC), thereby preventing the striker from striking unintentionally.

When the transmission construction is in the disengaged state, the drive wheel and the rotary shaft are released from the unidirectional-rotation locking, so that the drive wheel and the rotary shaft can rotate in the opposite direction relative to the output shaft; now, the striker is released and can be driven by the piston to move towards the bottom dead center.

This improved structure of the speed reducer allows for the striker to move from the top dead center towards the bottom dead center only when the transmission construction is in the transmission disengaged state, which ensures operating safety of the tool.

Optionally, the second-stage planetary carrier 3129, the third-stage sun gear 3131, and the ratchet 3135 may be one-piece formed or may be separately formed and then fixed together.

Optionally, the elastic plate 342 may also be replaced by a spring.

Optionally, the latch, the locking spring, and the unlocking member described in the first implementation may be provided or canceled. In a case of cancelling the latch, the limiting construction 340 is leveraged to lock the output shaft to rotate unidirectionally, whereby the striker is locked to the ready position.

Optionally, the ratchet 3135 may also be arranged on the first-stage planetary carrier, or on the third-stage planetary carrier, or on the output shaft, and the limiting construction 340 is disposed corresponding to the ratchet 3135.

The remaining structures of the second implementation are identical to those of the first implementation, which will not be detailed here.

### Third Implementation

Referring to FIG. 28, in this implementation, a bulge 363 bulged outwardly is arranged in a peripheral direction of the unlocking member 360, the unlocking member 360 adopting a cam structure. When the unlocking member 360 rotates till the bulge 363 abuts against the latch 710, the latch 710 is stressed to move from the locked state to the unlocked state. When the bulge 363 migrates from the latch 710, the latch 710 is released by the unlocking member 360, and the locking spring recovering from deformation may drive the released latch 710 to return to the locked state from the unlocked state.

Optionally, the latch 710 may be slidably disposed or may be swingingly disposed.

Optionally, the unlocking member 360 may be arranged on the rotary shaft 320 and one-piece formed with the drive wheel 330; or, the unlocking member 360 may be separately provided on the rotary shaft 320 or the output shaft 3121.

Optionally, the limiting construction described in the second implementation may also be set in the speed reducer in this implementation.

The remaining structures of the third implementation are identical to those of the first implementation, which will not be detailed here.

### Fourth Implementation

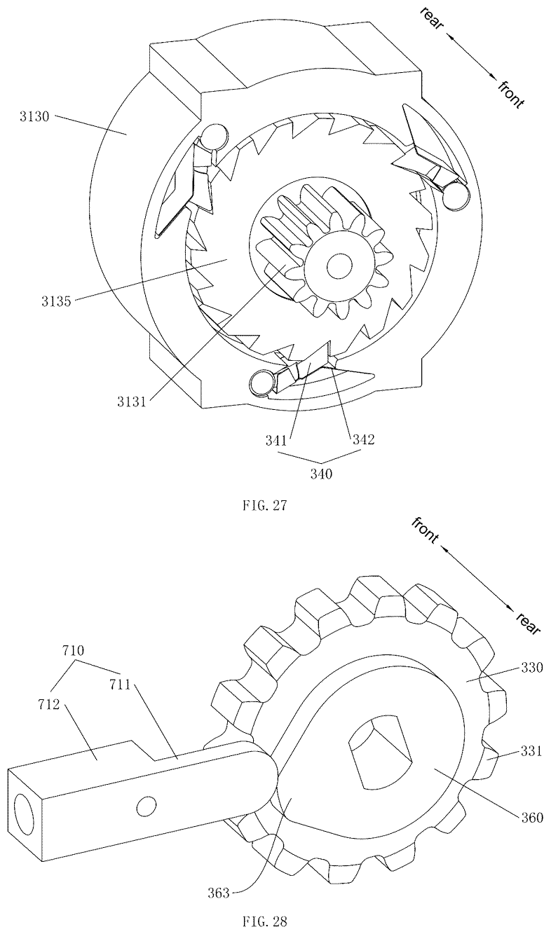

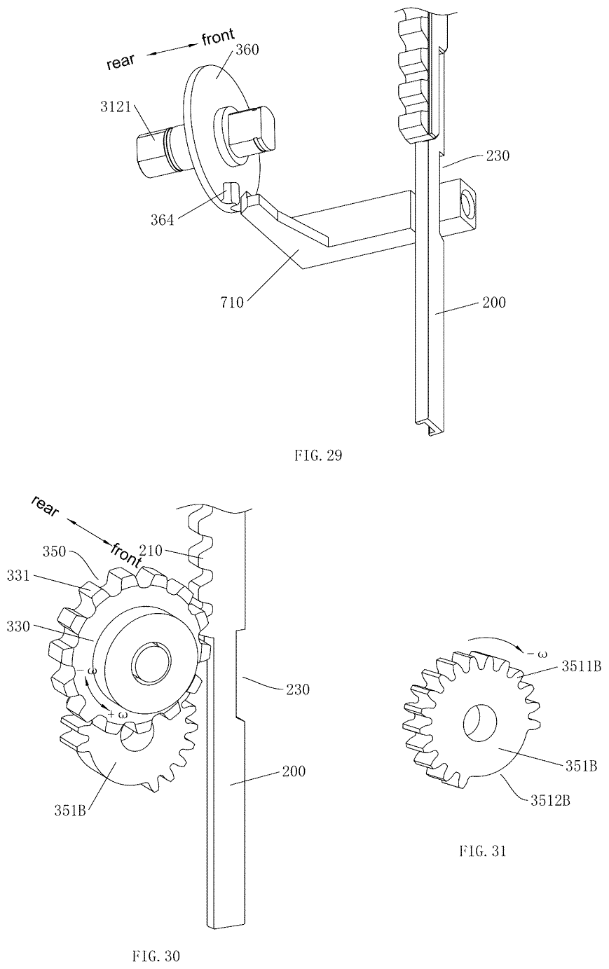

Referring to FIG. 29, in this implementation, a protrusion 364 is arranged on one end surface of the unlocking member 360, and one end of the latch 710 is provided with a beveled push surface fitted with the protrusion 364; when the unlocking member 360 rotates till the protrusion 364 abuts against the beveled push surface, the latch 710 is stressed to overcome the prestress force of the locking spring to move from the locked state to the unlocked state. When the protrusion 364 migrates from the latch 710, the latch 710 is released by the unlocking member 360, and the locking spring recovering from deformation may drive the released latch 710 to return from the unlocked state to the locked state.

Optionally, the latch 710 may be slidably disposed or may be swingingly disposed.

Optionally, the unlocking member 360 may be disposed on the rotary shaft 320 and one-piece formed with the drive wheel 330; or, the unlocking member 360 may be separately provided on the rotary shaft 320 or the output shaft 3121.

Optionally, the limiting structure described in the second implementation may also be provided in the speed reducer in this implementation.

The remaining structures of the fourth implementation are identical to those of the first implementation, which will not be detailed here.

### Fifth Implementation

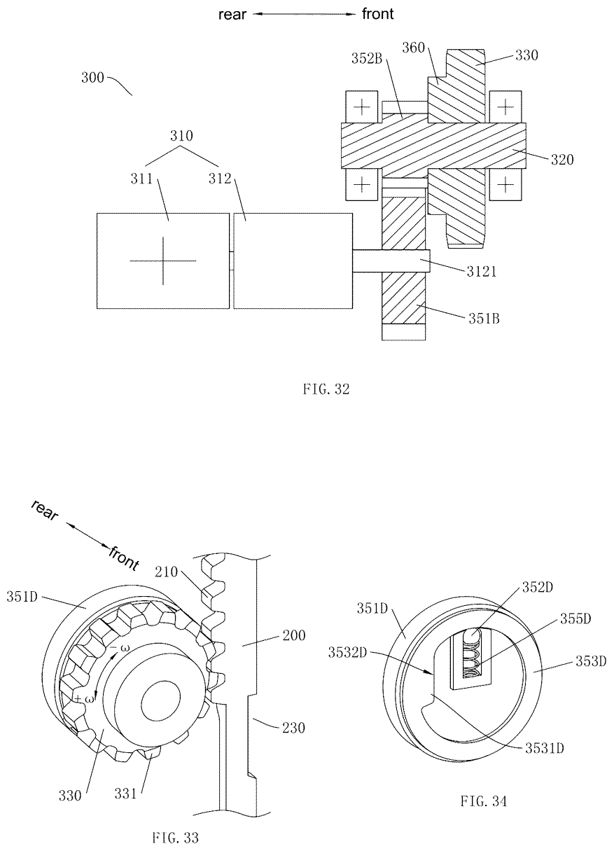

Referring to FIGS. 30 through 32, in this implementation, the transmission construction 350 comprises a master wheel II 351B actuated by the output shaft 3121 to rotate and a slave wheel II 352B disposed on the rotary shaft 320, a driving tooth 3511B and a non-toothed portion 3512B being arranged on an outer edge of the master wheel II 351B, a plurality of driving teeth 3511B being arranged at intervals along the peripheral direction of the master wheel II 351B, the non-toothed portion 3512B being arranged between the driving tooth 3511B at head and the driving tooth 3511B at tail, the slave wheel II 352B meshing with the driving teeth 3511B of the master wheel II 351B to dispose the transmission construction 350 in the engaged state, the non-toothed portion 3512B of the master wheel II 351B interrupts the meshing with the slave wheel II 352 B so that the transmission construction 350 is disposed in the disengaged state.

In this implementation, the master wheel II 351B is directly sleeved on the output shaft 3121, or the master wheel II 351B is driven to rotate by the output shaft 3121 via another gear. The driving teeth 3511B on the outer edge of the master wheel II 351B are distributed continuously at intervals along the periphery direction, and no teeth are arranged for the non-toothed portion 3512B at the outer edge of the master wheel II 351B, an outer diameter of the non-toothed portion 3512B being substantially equal to a root circle diameter of the driving teeth 3511B. When the master wheel II 351B rotates till the non-toothed portion 3512B is aligned with the slave wheel II 352B, the master wheel II 351B does not mesh with the slave wheel II 352B, so that the transmission construction 350 switches to the disengaged state. When the master wheel II 351B continues rotating till the driving tooth 3511B re-meshes with the slave wheel II 352B, the transmission construction 350 resumes the engaged state. The rotary shaft 320 and the output shaft 3121 are parallel arranged, with their central axes not coinciding; the slave wheel II 352B is sleeved on the rotary shaft 320 or is one-piece formed with the rotary shaft 320. The unlocking member 360 may be one-piece formed with the drive wheel 330, or may be one-piece formed with the slave wheel II 352B, or may be one-piece formed with the rotary shaft 320; the rotary shaft 320, the drive wheel 330, the unlocking member 360, and the slave wheel II 352B may also be one-piece formed.

In the non-firing state, the latch is inserted in the locking slot 230 so as to lock the striker 200 to the ready position, a certain number of teeth at the lower end of the striker 200 have not meshed with the drive wheel 330 yet, and the transmission construction 350 is in the engaged state.

To fire a nail, the output shaft 3121 drives the master wheel II 351B to rotate reversely in the direction indicated by −ω, the reversely rotating master wheel II 351 B drives the slave wheel II 352B meshing therewith to rotate forwardly in the direction indicated by +ω, the forwardly rotating slave wheel II 352B drives, via the rotary shaft 320, the drive wheel 330 to rotate forwardly, the unlocking member 360 rotates forwardly with the drive wheel 330 to drive the latch to switch from the locked state to the unlocked state so that the striker 200 is released, and the forwardly rotating drive wheel 330 drives the striker 200 to move upward from the ready position to the top dead center (TDC). When the striker 200 moves to the top dead center (TDC), the driving teeth 3511B on the master wheel II 351B migrate from the slave wheel II 352B, the piston under the pressure of the pressurized gas drives the striker 200 to move rapidly from the top dead center (TDC) to the bottom dead center (BDC); during the process of downward movement of the striker 200, the master wheel II 351B does not mesh with the slave wheel II 352B, so that the transmission construction 350 is disposed in the disengaged state, the output shaft 3121 cannot transmit, via the transmission construction 350, power to the slave wheel II 352B and thusly cannot drive the rotary shaft 320 and the drive wheel 330 to rotate forwardly; now, the slave wheel II 352B may rotate reversely relative to the master wheel II 351B, whereby the drive wheel 330 and the rotary shaft 320 can also rotate reversely.

During downward movement of the striker 200, the striker 200 drives the drive wheel 330 to rotate reversely in the direction indicated by −ω. After the striker 200 moves downward till the bottom dead center (BDC), the master wheel II 351B driven by the output shaft 3121 rotates to re-mesh with the slave wheel II 352B so that the transmission construction 350 resumes the engaged state, the master wheel II 351B which meshes with the slave wheel II 352B drives the rotary shaft 320 and the drive wheel 330 to rotate forwardly in the direction indicated by +ω, and the forwardly rotating drive wheel 330 drives the striker 200 and the piston to move upward to return to the ready position due to meshing between the transmission teeth 331 and the convex teeth 210. When the striker 200 returns to the ready position, the latch is inserted in the locking slot 230 to lock the striker 200 to the ready position.

Optionally, the unlocking member 360 may also be arranged on the output shaft 3121, and the unlocking member 360 may also be one-piece formed with the master wheel II 351B.

Optionally, the latch described in the first implementation may also be adopted in this fifth implementation so as to lock the striker 200 to the ready position; the limiting construction in the second implementation may also be adopted to lock the striker 200 to the ready position; the latch and the limiting construction may be both adopted to lock the striker 200 to the ready position. If the latch is canceled, the unlocking member is also canceled.

The remaining structures of the fifth implementation are identical to those of the first implementation, which will not be detailed here.

### Sixth Implementation

Referring to FIGS. 33 through 35, the transmission construction 350 comprises a master wheel IV 351D driven by the output shaft 3121 to rotate, a transmission member 352D radially movably disposed on the master wheel IV 351D, a clutch carrier 353D disposed between the master wheel IV 351D and the drive wheel 330, a transmission slot 354D provided on the drive wheel 330, and an elastic element II 355D biasing the transmission member 352D towards the transmission slot 354D, the transmission member 352D biased by the elastic element II 355D being inserted in the transmission slot 354D so that the transmission construction 350 is disposed in the engaged state, a bump 3531D allowing for the transmission member 352D to overcome a biasing force imposed by the elastic element II 355D so as to migrate out of the transmission slot 354D being provided on the clutch carrier 353D, migration of the transmission member 352D out of the transmission slot 354D disposing the transmission construction 350 in the disengaged state.

When the transmission member 352D biased by the elastic element II 355D is inserted in the transmission slot 354D, the transmission construction 350 is disposed in the engaged state, and the output shaft 3121 may drive, via the transmission construction 350, the drive wheel 330 to rotate forwardly in the direction indicated by +ω, so that the drive wheel 330 may drive the striker 200 to move upward to return to its ready position. Under the action of the bump 3531D, the transmission member 352D overcomes the biasing force imposed by the elastic element II 355D to migrate out of the transmission slot 354D, the transmission construction 350 is disposed in the disengaged state; now, the drive wheel 330 may rotate reversely relative to the output shaft 3121.

In this implementation, the master wheel IV 351D is sleeved on the output shaft 3121, a groove extending in a radial direction is provided at one side of the master wheel IV 351D facing the clutch carrier 353D, and a groove extending in a radial direction is also provided at one side of the drive wheel 330 facing the clutch carrier 353D, the groove on the master wheel IV 351D and the groove on the drive wheel 330 being combined to form an accommodation groove configured to receive the transmission member 352D and the elastic element II 355D, the transmission member 352D and the elastic element II 355D being disposed in the accommodation groove. The clutch carrier 353D is fixedly arranged between the master wheel IV 351D and the drive wheel 330, the clutch carrier 353D being formed of a flat ring shape, the bump 3531D protruding from an inner ring surface of the clutch carrier 353D to the center thereof, the transmission member 352D and the elastic element II 355D being disposed at an inner periphery of the clutch carrier 353D, the bump 3531D being provided with a abutting surface 3532D which may be arranged parallel to a radial direction of the clutch carrier 353D. The elastic element II 355D biases the transmission member 352D towards the transmission slot 354D so that the transmission member 352D biased by the elastic element II 355D is inserted in the transmission slot 354D, whereby the transmission construction 350 is disposed in the engaged state; the master wheel IV 351D driven by the output shaft 3121 to rotate drives, via fitting between the transmission member 352D and the transmission slot 354D, the drive wheel 330 to rotate forwardly in the direction indicated by +ω, and the forwardly rotating drive wheel 330 may drive the striker 200 to move upward. When the master wheel IV 351D drives the transmission member 352D and the elastic element II 355D to rotate till contacting the abutting surface 3532D of the bump 3531D, the transmission member 352D is forced by the abutting surface 3532D to overcome the biasing force imposed by the elastic element II 355D to move towards the center of the master wheel IV 351D, whereby the transmission member 352D migrates out of the transmission slot 354D on the drive wheel 330; now, without fitting between the transmission member 352D and the transmission slot 354D, the master wheel IV 351D cannot drive the drive wheel 330 to rotate, disposing the transmission construction 350 in the disengaged state so that the drive wheel 330 may rotate reversely relative to the master wheel IV 351D. As a feasible solution of this implementation, the transmission member 352D may be set with a reasonable structure such as a spherical shape, or a conical shape, or a column shape. As a feasible solution of this implementation, the elastic element II 355D may adopt an elastic element such as a spring or a spring plate.

In a non-firing state, the latch is inserted in the locking slot 230 to lock the striker 200 to the ready position, a certain number of teeth at the lower end of the striker 200 have not meshed with the drive wheel 330 yet, the transmission member 352D is fitted with the transmission slot 354D, and the transmission construction 350 is disposed in the engaged state.

To fire a nail, the output shaft 3121 drives the master wheel IV 351D to rotate forwardly in the direction indicated by +ω, the forwardly rotating master wheel IV 351D drives, via fitting between the transmission member 352D and the transmission slot 354D, the drive wheel 330 to rotate forwardly in the direction indicated by +ω, the unlocking member 360 rotates with the drive wheel 330 to drive the latch to switch from the locked state to the unlocked state to release the striker 200, and the forwardly rotating drive wheel 330 drives the striker 200 to move upward from the ready position to the top dead center (TDC). When the striker 200 moves to the top dead center (TDC), the transmission member 352D is forced by the abutting surface 3532D to overcome the biasing force imposed by the elastic element II 355D to move towards the center of the master wheel IV 351D to migrate out of the transmission slot 354D, which disposes the transmission construction 350 in the disengaged state, so that the output shaft 3121 cannot transmit power to the drive wheel 330 via the transmission construction 350, whereby the drive wheel 330 and the rotary shaft 320 may rotate reversely in the direction indicated by −ω.

During downward movement of the striker 200, the striker 200 drives the drive wheel 330 to rotate reversely in the direction indicated by −ω. After the striker 200 moves downward to the bottom dead center (BDC), the transmission member 352D migrates from the bump 3531D; and when the master wheel IV 351D and the drive wheel 330 rotate till the transmission member 352D and the transmission slot 354D are re-aligned, the transmission member 352D is biased by the elastic element II 355D to be re-inserted into the transmission slot 354D, and the transmission construction 350 resumes the engaged state; the forwardly rotating master wheel IV 351D drives, via fitting between the transmission member 352D and the transmission slot 354D, the drive wheel 330 to rotate forwardly along the direction indicated by +ω, and the forwardly rotating drive wheel 330 drives, via meshing between the transmission teeth and the convex teeth, the striker 200 and the piston to move upward to return. When the striker 200 returns to the ready position, the latch is inserted in the locking slot 230 to lock the striker 200 to the ready position.

Optionally, the unlocking member 360 may be disposed on the output shaft 3121 and one-piece formed with the master wheel IV 351D; the unlocking member 360 may also be separately provided and sleeved on the output shaft 3121; the unlocking member 360, the master wheel IV 351D, and the output shaft 3121 may be one-piece formed.

Alternatively, the master wheel IV 351D may be driven to rotate by the output shaft 3121 via another gear.

Alternatively, the transmission construction 350 further comprises a slave wheel IV arranged co-axial with the drive wheel 330, the slave wheel IV being arranged on the rotary shaft 320, the clutch carrier 353D being disposed between the master wheel IV 351D and the slave wheel IV, the transmission slot 354D being disposed on the slave wheel IV, whereby the master wheel IV 351D may drive, via fitting between the transmission member 352D and the transmission slot 354D, the slave wheel IV to rotate forwardly, and the forwardly rotating slave wheel IV drives, via the rotary shaft 320, the drive wheel 330 to synchronously rotate forwardly.

Optionally, the latch described in the first implementation may also be adopted in this sixth implementation so as to lock the striker 200 to the ready position; the limiting construction in the second implementation may also be adopted to lock the striker 200 to the ready position; the latch and the limiting construction may also be both adopted to lock the striker 200 to the ready position. If the latch is canceled, the unlocking member is also canceled.

The remaining structures of the sixth implementation are identical to those of the first implementation, which will not be detailed here.

### Seventh Implementation

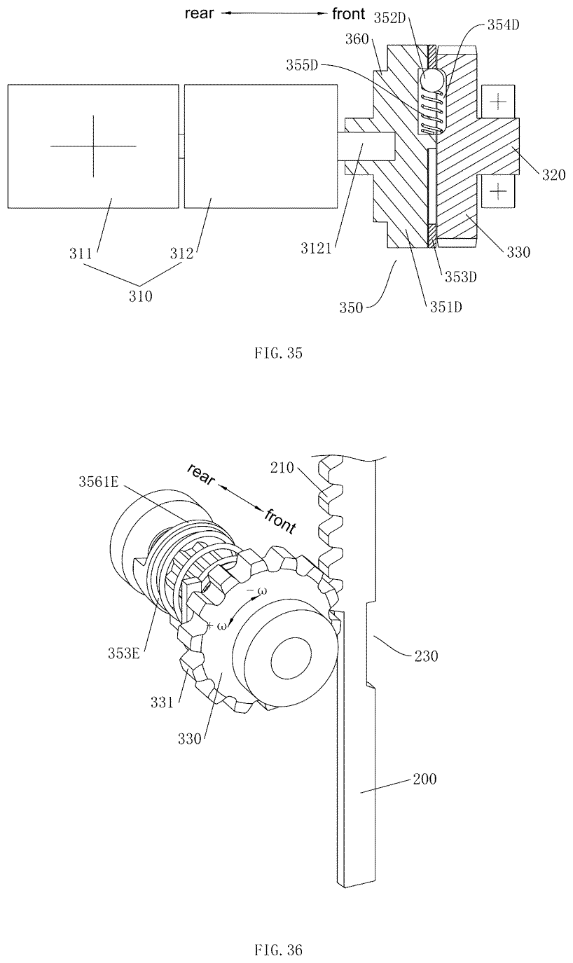

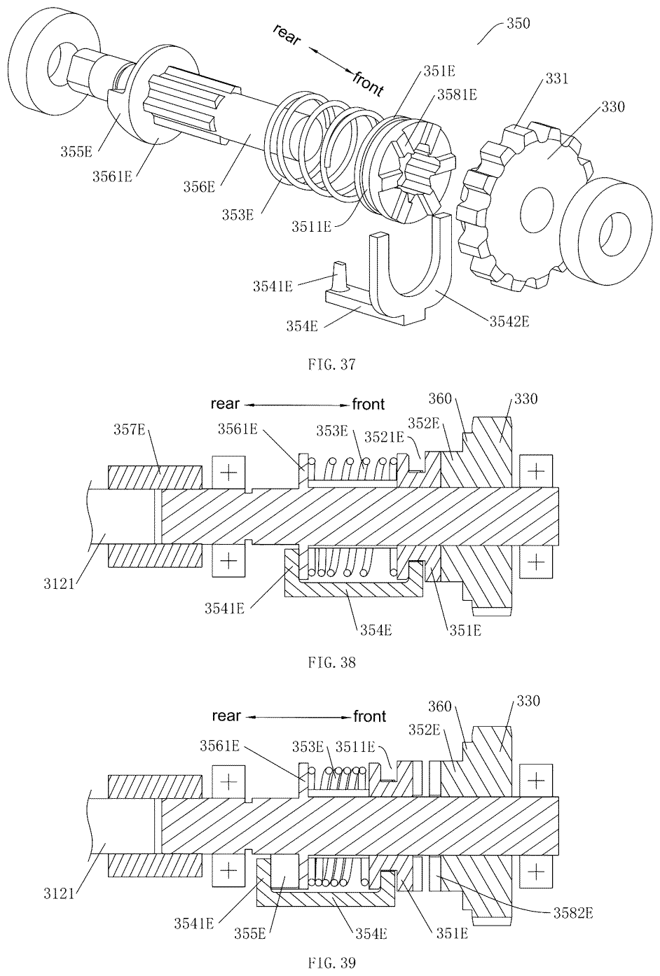

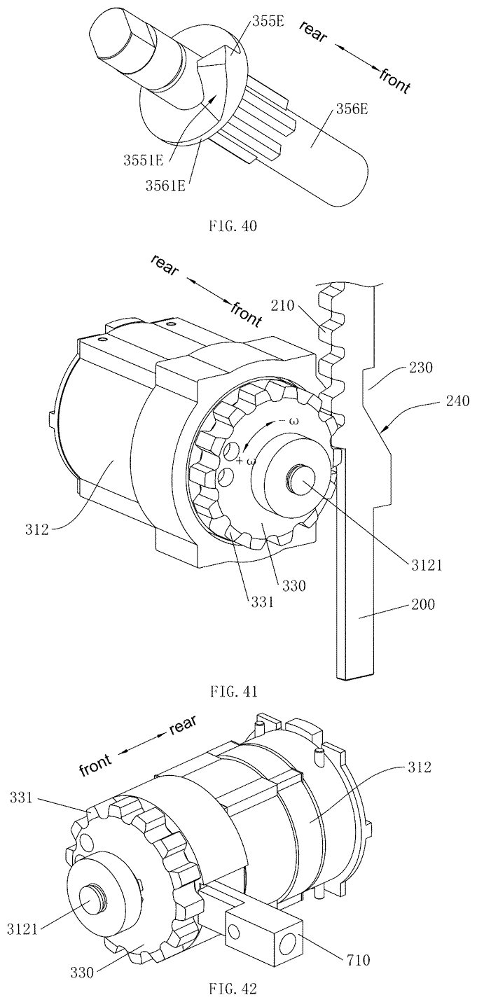

Referring to FIGS. 36 through 40, the transmission construction 350 comprises a master wheel V 351E driven by the output shaft 3121 to rotate, a slave wheel V 352E rotating synchronously with the drive wheel 330, an elastic element III 353E biasing the master wheel V 351E towards the slave wheel V 352E, a deflecting fork 354E fitted with the master wheel V 351E, and a driving block 355E configured to drive the deflecting fork 354E to slide axially; the master wheel V 351E biased by the elastic element III 353E is fitted with the slave wheel V 352E to dispose the transmission construction 350 to the engaged state, and the driving block 355E rotating with the output shaft 3121 drives, via the deflecting fork 354E, the master wheel V 351E to overcome a biasing force imposed by the elastic element III 353E to migrate from the slave wheel V 352E so that the transmission construction 350 is disposed in the disengaged state.

When the master wheel V 351E is biased by the elastic element III 353E so as to be disposed fitting with the slave wheel V 352E, the transmission construction 350 is in the engaged state, the output shaft 3121 may drive, via the master wheel V 351E and the slave wheel V 352E, the drive wheel 330 to rotate forwardly, and the forwardly rotating drive wheel 330 may drive the striker 200 to move upward to return. When the driving block 355E drives the deflecting fork 354E to move in a direction away from the slave wheel V 352E, the deflecting fork 354E drives the master wheel V 351E to slide synchronously so that the master wheel V 351E migrates from the slave wheel V 352E, disposing the transmission construction 350 to the disengaged state; now, the drive wheel 330 may rotate reversely relative to the master wheel V 351E.

In this implementation, the transmission construction 350 further comprises a transmission shaft 356E which is in transmission connection with the output shaft 3121 via a coupling sleeve 357E; the master wheel V 351E is sleeved on the transmission shaft 356E via a non-circular shaft hole fitting structure or a spline fitting structure, so that the master wheel V 351E may slide axially relative to the transmission shaft 356E. The slave wheel V 352E and the drive wheel 330 are both sleeved on the transmission shaft 356E via interference-fitting, and the slave wheel V 352E and the drive wheel 330 may both rotate circumferentially relative to the transmission shaft 356E; the slave wheel V 352E and the drive wheel 330 may be one-piece formed, or may be separately provided and then fixed together. Alternatively, the transmission shaft 356E may also be one-piece formed with the output shaft 3121.

A disc body 3561E disposed at a rear end of the master wheel V 351E is provided on the transmission shaft 356E, and the driving block 355E is provided at one side of the disc body 3561E facing away from the master wheel V 351E; the driving block 355E, the disc body 3561E, and the transmission shaft 356E may be one-piece formed. A columnar rod 3541E fitted with the driving block 355E is provided at a rear end of the deflecting fork 354E, a U-shaped fork lever 3542E is provided at a front end of the deflecting fork 354E, and an annular groove 3511E is provided on an outer peripheral surface of the master wheel V 351E; the fork lever 3542E is always partially inserted in the annular groove 3511E, and the deflecting fork 354E realizes fit with the master wheel V 351E via fitting between the fork lever 3542E and the annular groove 3511E.

Snap teeth 3581E and snap-in recesses 3582E are distributed at intervals on opposite end surfaces of the master wheel V 351E and the slave wheel V 352E along their respective peripheral directions; when the snap teeth 3581E are inserted in the snap-in recesses 3582E, the master wheel V 351E is interlocked with the slave wheel V 352E; when the snap teeth 3581E migrate out of the snap-in recesses 3582E, the master wheel V 351E migrates from the slave wheel V 352E.

The elastic element III 353E is disposed between the disc body 3561E and the master wheel V 351E; the elastic element III 353E may adopt a spring, an elastic plate, or another elastic member. If the elastic element III 353E is a spring, the elastic element III 353E may be sleeved outside the transmission shaft 356E, a rear end of the elastic element III 353E abutting against the disc body 3561E so as to be positionally retained, a front end of the elastic element III 353E abutting against the master wheel V 351E so as to bias the master wheel V 351E towards the slave wheel V 352E.

The master wheel V 351E is biased by the elastic element III 353E so that the snap teeth 3581E are inserted in the snap-in recesses 3582E, disposing the transmission construction 350 to the engaged state; the transmission shaft 356E driven to rotate by the output shaft 3121 drives, via the master wheel V 351E and the slave wheel V 352E, the drive wheel 330 to rotate forwardly in the direction indicated by +ω, and the forwardly rotating drive wheel 330 may drive the striker 200 to move upward to return in place.

The driving block 355E is provided with a driving surface 3551E inclining axially relative to the transmission shaft 356E; the transmission shaft 356E drives the driving block 355E to rotate synchronously; when the driving block 355E rotates till the columnar rod 3541E contacts the driving surface 3551E, the driving block 355E drives the deflecting fork 354E to move rearward; the rearwardly moving deflecting fork 354E drives the master wheel V 351E to overcome the biasing force imposed by the elastic element III 353E to slide rearward relative to the transmission shaft 356E; the rearwardly sliding master wheel V 351E migrates from the slave wheel V 352E, disposing the transmission construction 350 to the disengaged state so that the drive wheel 330 and the slave wheel V 352E may rotate reversely relative to the master wheel V 351E.

In a non-firing state, the latch is inserted in the locking slot 230 to lock the striker 200 to the ready position; a certain number of teeth at the lower end of the striker 200 have not meshed with the drive wheel 330 yet; the master wheel V 351E is interlocked with the slave wheel V 352E, disposing the transmission construction 350 in the engaged state.

To fire a nail, the output shaft 3121 drives, via the transmission shaft 356E, the master wheel V 351E to rotate forwardly along the direction indicated by +ω, the forwardly rotating master wheel V 351E drives, via interlocking between the snap teeth 3581E and the snap-in recesses 3582E, the slave wheel V 352E to rotate forwardly in the direction indicated by +ω, the slave wheel V 352E drives the drive wheel 330 to synchronously rotate forwardly, the unlocking member 360 rotates therewith to drive the latch to switch from the locked state to the unlocked state to thereby release the striker 200, and the forwardly rotating drive wheel 330 drives the striker 200 to move upward from the ready position to the top dead center (TDC).

When the striker 200 moves to the top dead center (TDC), the deflecting fork 354E drives, due to abutment between the columnar rod 3541E and the driving surface 3551E, the master wheel V 351E to overcome the biasing force imposed by the elastic element III 353E to slide rearwardly, so that the master wheel V 351E migrates from the salve wheel V 352E, disposing the transmission construction 350 in the disengaged state, whereby the output shaft 3121 cannot transmit power to the drive wheel 330 via the transmission construction 350 so that the drive wheel 330 may rotate reversely in the direction indicated by −ω.

During downward movement of the striker 200, the striker 200 drives the drive wheel 330 to rotate reversely in the direction indicated by −ω. When the striker 200 moves downward to the bottom dead center (BDC), the columnar rod 3541E migrates from the driving block 355E; when the master wheel V 351E and the slave wheel V 352E rotate till the snap teeth 3581E are re-aligned with the snap-in recesses 3582E, the master wheel V 351E is biased by the elastic element III 353E to slide forward so that the snap teeth 3581E are re-inserted in the snap-in recesses 3582E and the transmission structure 350 resumes the engaged state; the forwardly rotating transmission shaft 356E drives, via the master wheel V 351E and the slave wheel V 352E, the drive wheel 330 to rotate forwardly along the direction indicated by +ω; the forwardly rotating drive wheel 330 drives, via meshing between the transmission teeth and the convex teeth, the striker 200 and the piston to move upward to return. When the striker 200 returns to the ready position, the latch is inserted in the locking slot 230 so as to lock the striker 200 to the ready position.

Optionally, the unlocking member 360, the drive wheel 330, and the slave wheel V 352 E may be one-piece formed, or may be separately formed and then fixed together.

Optionally, the latch described in the first implementation may also be adopted in this seventh implementation so as to lock the striker 200 to the ready position; the limiting construction in the second implementation may also be adopted to lock the striker 200 to the ready position; the latch and the limiting construction may also be both adopted to lock the striker 200 to the ready position. If the latch is canceled, the unlocking member is also canceled.

The remaining structures of the seventh implementation are identical to those of the first implementation, which will not be detailed here.

### Eighth Implementation

Referring to FIGS. 41 to 43, in this implementation, the speed reducer 312 adopts a two-stage or three-stage or four-stage planetary gear reduction construction; the speed reducer 312 has a final-stage sun gear 312a, a final-stage planetary gear 312b, and a final-stage inner ring gear 312c, two or three or four final-stage planetary gears 312b being arranged at intervals along an outer periphery of the final-stage sun gear 312a, respective final-stage planetary gears 312b simultaneously meshing with the final-stage sun gear 312a and the final-stage inner ring gear 312c, the final-stage inner ring gear 312c being rotatably arranged in a front end of the speed reducer 312. The drive wheel 330 may be attached to respective final-stage planetary gears 312b via the planetary carrier; now, shafts configured to support respective final-stage planetary gears 312b are fixed to the planetary carrier, the rear end of the output shaft 3121 is fixed to the planetary carrier, and the drive wheel 330 is sleeved on the output shaft 3121. The drive wheel 330 may also be directly attached to respective final-stage planetary gears 312b, in which case the shafts configured to support respective final-stage planetary gears 312b are directly fixed to the drive wheel 330.

A limiting groove 3121c is arranged on an outer peripheral surface of the final-stage inner ring gear 312c; the latch 710 is not only configured to lock the striker 200 to the ready position, but also configured to lock the final-stage inner ring gear 312c. In this implementation, an unlocking beveled surface 240 arranged incliningly relative to a side surface of the striker 200 is provided for the striker 200 at a bottom side of the locking slot 230, the unlocking beveled surface 240 being configured to switch the latch 710 from the locked state to the unlocked state.

In a non-firing state, the latch 710 is inserted in the locking slot 230 so as to lock the striker 200 to the ready position, and a certain number of teeth at the lower end of the striker 200 have not meshed with the drive wheel 330; meanwhile, the latch 710 is partially inserted in the limiting groove 3121c in the final-stage inner ring gear 312c so that the final-stage inner ring gear 312c is circumferentially limited.

To fire a nail, the output shaft 3121 drives the drive wheel 330 to rotate forwardly in the direction indicated by +ω; the forwardly rotating drive wheel 330 drives the striker 200 to move upward, and the upwardly moving striker 200 switches, via the unlocking beveled surface 240, the latch 710 from the locked state to the unlocked state. When the striker 200 moves to the top dead center (TDC), the latch 710 completely migrates out of the limiting groove 3121c so that the final-stage inner ring gear 312c is unlocked, disposing the final-stage inner ring gear 312c in a rotatable state. Now, the electric motor halts, the final-stage sun gear 312c is in a static state, the final-stage inner ring gear 312c and the final-stage planetary gears 312b are in a rotatable state, the piston forced by the pressurized gas drives the striker 200 to move from the top dead center (TDC) to the bottom dead center (BDC), the downwardly moving striker 200 drives the drive wheel 330 to rotate reversely in the direction indicated by −ω, the reversely rotating drive wheel 330 drives, via the output shaft 3121, respective final-stage planetary gears 312b to revolve in the direction indicated by −ω and meanwhile the final-stage planetary gears 312b may also self-rotate, the final-stage inner ring gear 312c may also be driven by the final-stage planetary gear 312b to rotate, the final-stage sun gear 312c still maintains static to resist the drive wheel 330 against continued rearward transmission of the reverse rotation.

When the final-stage inner ring gear 312c rotates till the limiting groove 3121c is re-aligned with the latch 710, the latch 710 is first inserted in the limiting groove 3121c so that the final-stage inner ring gear 312c stops rotation, then the electric motor is activated, the final-stage sun gear 312c is driven to rotate, the final-stage sun gear 312c drives, via the final-stage planetary gears 312b and the final-stage planetary carrier, the output shaft 3121 to rotate forwardly in the direction indicated by +ω, the output shaft 3121 drives the drive wheel 330 to synchronously rotate forwardly, and the forwardly rotating drive wheel 330 drives the striker 200 to move upward. When the striker 200 moves upward to the ready position, the electric motor halts, and the latch 710 switches to the locked state to lock the striker 200 to the ready position.

The remaining structures of the eighth implementation are identical to those of the first implementation, which will not be detailed here.

### Ninth Implementation

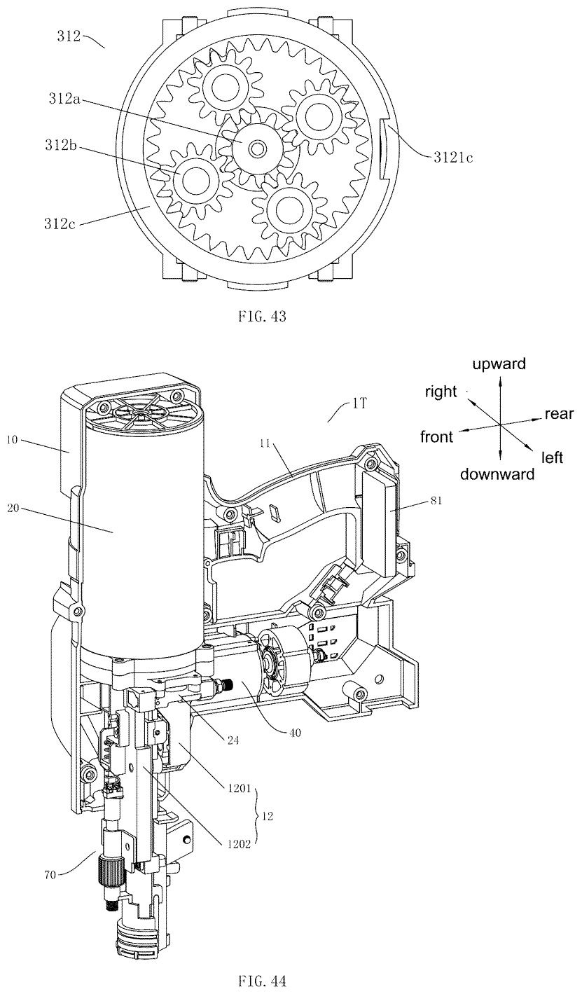

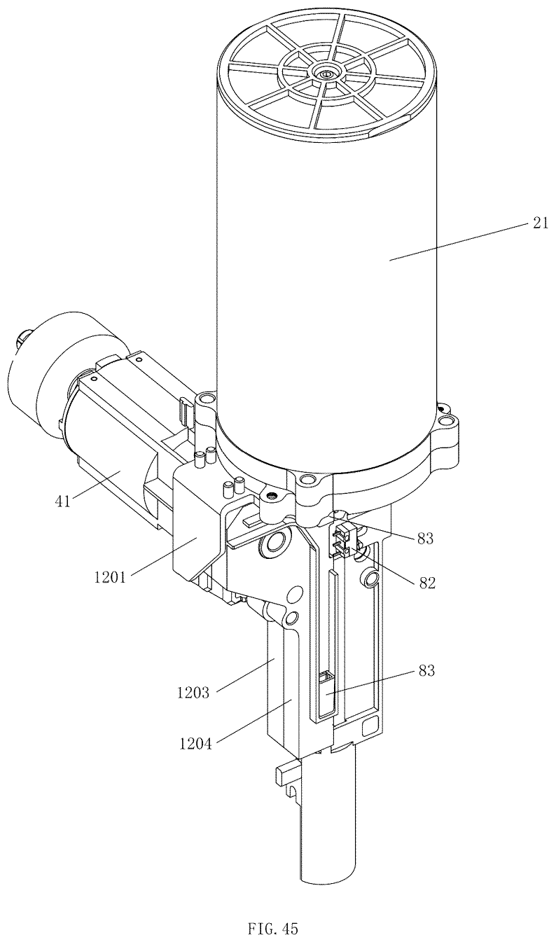

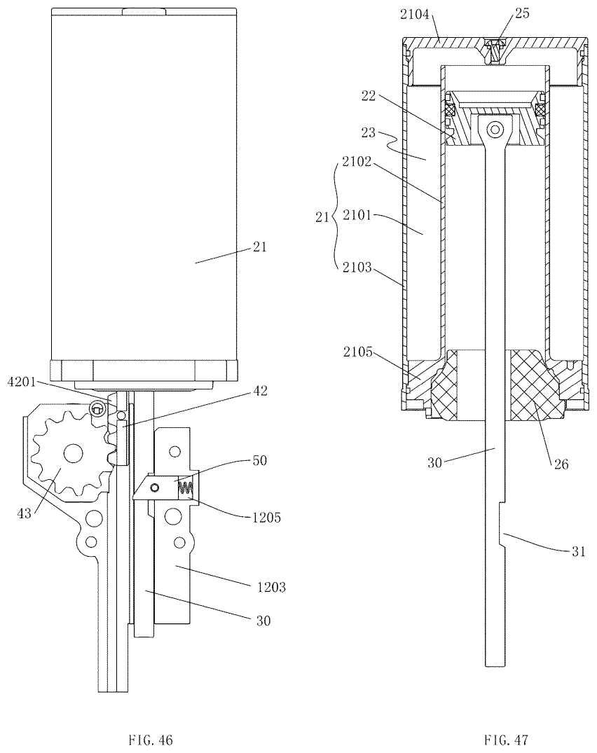

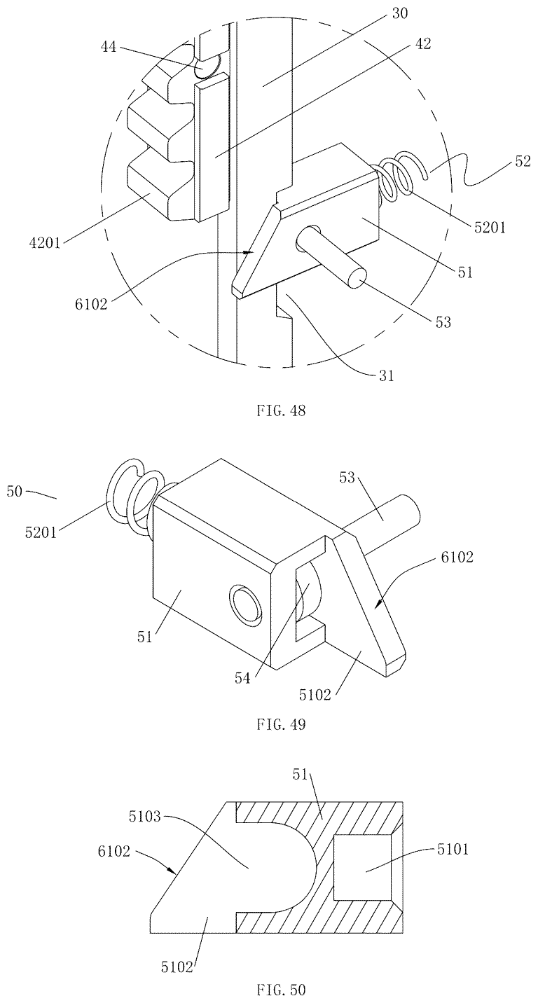

Referring to FIGS. 44 through 50, a nineth implementation of the disclosure provides a nail gun 1T, which relates to a fastener driving tool, comprising:
a housing 10 provided with a handle 11;
an energy accumulation assembly 20 disposed in the housing 10, the energy accumulation assembly 20 comprising a cylinder construction 21 and a piston 22, the cylinder construction 21 having an energy accumulation chamber 2101, the piston 22 being movably disposed in the cylinder construction 21, the piston 22 moving to induce volume change of the energy accumulation chamber 2101;
a striker 30 attached to the piston 22, a top dead center and a bottom dead center being provided for the striker 30 and the piston 22, the striker 30 being driven by the piston 22 to move downward from the top dead center to the bottom dead center;
and a drive assembly 40 comprising an electric motor 41 and a movable member 42, the electric motor 41 driving the movable member 42 to move reciprocally between the bottom dead center and the top dead center;
and the nail gun 1T further comprises a locking assembly 50, the locking assembly 50 having a locked state in which the locking assembly 50 is fitted with the striker 30 to lock the striker 30 to the top dead center and an unlocked state in which the locking assembly 50 migrates from the striker 30;
a fit releasing construction 61 disposed between the movable member 42 and the locking assembly 50, the fit releasing construction 61 being operable to switch the locking assembly 50 from the locked state to the unlocked state during a process of the movable member 42 moving downward from the top dead center to the bottom dead center;
and a transmission fit construction 62 engageable and disengaged, which is disposed between the movable member 42 and the striker 30, the movable member 42 when moving upward driving, via the transmission fit construction 62, the striker 20 and the piston 22 to move upward from the bottom dead center to the top dead center so that the piston 22 compresses an energy accumulation medium 23 in the energy accumulation chamber 2101 to accumulate energy.

The energy accumulation assembly 20, the striker 20, the locking assembly 50, and the movable member 42 are arranged in a front portion of the housing 10, the handle 11 is arranged at a rear portion of the housing 10, and the electric motor 41 is arranged in the housing 10 beneath the handle 11. The nail gun IT further comprises a feeder assembly in which nails are loaded, and the nails in the feeder assembly, when being pushed by a push block, may move from a tail end to a head end of the feeder assembly to access a ready position. The head end of the feeder assembly is further provided with a safety ejection rod assembly 70 (not completely shown) disposed at a lower end of the housing 10; the safety ejection rod assembly 70 may not only ensure nail driving safety, but also may adjust nail driving depth. Specific structures of the feeder assembly and the safety ejection rod assembly 70 may refer to specific descriptions in the patent literatures such as CN109623737B, U.S. Pat. No. 11,478,912B2, and EP3670093A1, which will not be detailed here.

Exemplarily, the cylinder construction 21 of the energy accumulation assembly 20 comprises an inner cylinder sleeve 2102 disposed inside and an outer cylinder sleeve 2103 disposed outside, a rear cover 2104 being secured at a rear end of the outer cylinder sleeve 2103, the rear cover 2104 and the rear end of the outer cylinder sleeve 2103 maintaining circumferentially hermetically fitted. A circle of projecting rim 2105 positioned at an inner periphery of a lower end of the outer cylinder sleeve 2103 is provided for a lower end of the inner cylinder 2102, the projecting rim 2105 maintaining circumferentially hermetically fitted with the lower end of the outer cylinder sleeve 2103. The piston 22 is up-down movably disposed in the inner cylinder sleeve 2102, the piston 22 maintaining circumferentially hermetically fitted with the inner cylinder sleeve 2102. A rear end of the inner cylinder sleeve 2102 is open so that an internal cavity of the inner cylinder sleeve 2102 communicates with an internal cavity of the outer cylinder sleeve 2103; the energy accumulation chamber 2101 is enclosed by the inner cylinder sleeve 2102, the outer cylinder sleeve 2103, and the piston 22; a gas is filled in the energy accumulation chamber 2101, which serves as the energy accumulation medium 23 in this implementation. The piston 22 moves upward to shrink a volume of the energy accumulation chamber 2101 so that the gas in the energy accumulation chamber 2101 is compressed and pressurized to allow for the energy accumulation medium 23 to accumulate energy. When the striker 30 is released, the piston 22 is forced by the pressurized gas in the energy accumulation chamber 2101 to drive the striker 30 to move downward to fire a nail; if the volume of the energy accumulation chamber 2101 increases, the gas in the energy accumulation chamber 2101 expands to decrease the gas pressure.

Alternatively, the energy accumulation medium 23 may be a gas-spring combination; in this case, the spring is disposed in the inner cylinder sleeve 2102, a gas is filled in the energy accumulation chamber 2101, and the piston 22 moves upward to compress the spring so that the volume of the energy accumulation chamber 2101 shrinks to compress the gas in the energy accumulation chamber 2101. When the striker 30 is released, the piston 22 is forced by both of the pressure of the pressurized gas inside the energy accumulation chamber 201 and the elastic force of the spring to drive the striker 30 to move downward to realize nail firing.

A stationary base assembly 12 is arranged in the housing 10, the stationary base assembly 12 comprising a base body 1201 and a base cover 1202 secured to one side of the base body 1201, the cylinder construction 21 being secured to a top portion of the base body 1201. To contribute a reasonable pressure range to the gas in the energy accumulation chamber 2101 so as to satisfy nail driving requirements, an inflation valve 910 configured to recharge gas into the energy accumulation chamber 2101 is secured to a bottom side of the base body 1201, and a pressure relief valve 25 is provided on the rear cover 2104. When the gas pressure of the compressed gas in the energy accumulation chamber 2101 does not satisfy nail driving requirements, the inflation valve 24 may recharge gas into the energy accumulation chamber 2101 to increase the pressure of the compressed gas. When the gas pressure in the energy accumulation chamber 2101 is too high, the pressure relief valve 25 may be opened to discharge the gas in the energy accumulation chamber 2101, whereby the gas pressure of the compressed gas decreases to an appropriate level.

To prevent the downwardly moving piston 22 from directly bumping into the base body 1201, an elastic shock absorption piece 26 is provided at a lower end of the inner cylinder sleeve 2102. When the piston 22 moves downward till contacting the shock absorption piece 26, the piston 22 and the striker 30 move downward to the bottom dead center. The striker 30 is formed of an elongated shape with its lengthwise direction set in an up-down manner, an upper end of the striker 30 being connected to the piston 22 via a pin shaft or an alternative connector, a lower end of the striker 30 projecting downward out of the energy accumulation assembly 20 via a through hole on the shock absorption piece 26.

Exemplarily, the drive assembly 40 comprises a gear 43 driven by the electric motor 41, the movable member 42 is formed of an elongated shape with its lengthwise direction set in an up-down manner, a plurality of transmission teeth 4201 arranged at intervals in an up-down direction are provided on the movable member 42, the transmission teeth 4201 mesh with the gear 43, and the electric motor 41 drives, via meshing between the gear 43 and the transmission teeth 4201, the movable member 42 to move up and down. Optionally, the electric motor 41 may directly drive the gear 43 to rotate after appropriate speed reduction; and the electric motor 41 may also drive the gear 43 to rotate via a gear rotation fitting structure or another transmission fitting structure after appropriate speed reduction.

In this implementation, a first rest plate 1203 and a second rest plate 1204 which are fixed together are disposed between the base body 1201 and the base cover 1202, the first base plate 1203 and the second base plate 1204 being fitted to form a through groove in which the movable member 42 and the striker 30 move up and down, the movable member 42 and the striker 30 passing through the through groove in an up-down movable manner. To enhance up-down movement stability of the movable member 42, a convex rib extending in the up-down direction may be arranged on the movable member 42, a recess extending in the up-down direction and fitted with the convex rib may be arranged on an inner wall of the through groove, and the movable member 42 is limited via fitting between the convex rib and the recess; of course, the positions where the convex rib and the recess are arranged may be exchanged with each other. To ensure a nail driving effect of the striker 30, the striker 30 does not contact the inner wall of the through groove, preventing the moving striker 30 from being subjected to a high friction.

Exemplarily, the locking assembly 50 comprises a locking block 51 and an elastic element 52 acting on the locking block 51, the elastic element 52 forcing the locking block 51 to abut towards the striker 30, the elastic element 52 being configured to be deformed under stress when the locking block 51 is driven by the fit releasing construction 61 to migrate from the striker 30, the locking block 51 and the striker 30 being fitted to lock the striker 30 to the top dead center when the striker 30 moves upward to the top dead center. Specifically, a slide groove 1205 configured to mount the locking block 51 is arranged between the first rest plate 1203 and the second rest plate 1204, the locking block 51 being slidably arranged in the slide groove 1205. The sliding direction of the locking block 51 is exemplarily perpendicular to the movement direction of the movable member 42 so as to minimize the sliding distance of the locking block 51 switching from the locked state to the unlocked state, which enhances effectiveness and stability of the movable member 52 driving, via the fit releasing construction 61, the locking block 51 to switch from the locked state to the unlocked state. The striker 30 is provided with a locking slot 31 fitted with the locking block 51, the locking block 51 being partially inserted in the locking slot 31 to abut against the inner wall of the locking slot 31, whereby the striker 30 is locked to the top dead center. The elastic element 52 exemplarily adopts a locking spring 5201, one end of the locking spring 5201 abutting on the inner wall of the slide groove 1205 so as to be positionally retained, an opposite end of the locking spring 5201 being inserted in a recessed hole 5101 on the locking block 51 so as to abut against the locking block 51; the locking spring 5201 is always in a compressed state and applies a force against the locking block 51 to press the locking block 51 to abut toward the striker 30. Alternatively, the elastic element may also adopt another elastic element satisfying requirements.

The fit releasing construction 61 comprises a releasing beveled surface arranged on at least one of the movable member 42 and the locking block 51, and the movable member 42 when moving downward from the top dead center to the bottom dead center drives, via the releasing beveled surface, the locking block 51 to slide to migrate from the striker 30. Exemplarily, a widened portion 4202 is provided at an upper end of the movable member 42, and a tongue piece 5102 which extends towards the movable member 42 to avoid the striker 30 is provided for the locking block 51; the fit releasing construction 61 comprises a first releasing beveled surface 6101 disposed at a lower end of the widened portion 4202 and a second releasing beveled surface 6102 disposed at a top side of the tongue piece 5102, the first releasing beveled surface 6101 and the second releasing beveled surface 6102 being parallel to each other. During a process of the movable member 42 moving from the top dead center to the bottom dead center, the abutment fitting between the first releasing beveled surface 6101 and the second releasing beveled surface 6102 drives the locking block 51 to slide in a direction away from the striker 30 so that the locking block 51 migrates from the striker 30; the two releasing beveled surfaces increase the contact area between the movable member 42 and the locking block 51, facilitating enhancement of the smoothness of the movable member 42 driving the locking block 51 to switch from the locked state to the unlocked state. To ensure that the abutment fitting between the first releasing beveled surface 6101 and the second releasing beveled surface 6102 may drive the locking block 51 to smoothly migrate from the striker 30, the inclination angles of the two releasing beveled surfaces may be set to an appropriate value such as 40°, 42°, 45°, 47°, 50°, 52°, 55°, 57°, and 60°. Alternatively, the sliding direction of the locking block 51 may be not perpendicular to the movement direction of the movable member 42. Alternatively, the fit releasing construction 61 may be provided only with the first releasing beveled surface 6102 or the second releasing beveled surface 6102.

Exemplarily, the locking assembly 50 further comprises a pressure bar 53 linked with the locking block 51; the nail gun 1T comprises a control 81 and a position switch 82 retained in the stationary base assembly 12, the position switch 82 communicating with the control module 81, the electric motor 41 being controlled by the control 81. The locking block 51 switching from the unlocked state to the locked state actuates the pressure bar 53 to trigger the position switch 82, and the locking block 51 switching from the locked state to the unlocked state actuates the pressure bar 53 to release the position switch 82. When the movable member 42 drives the striker 30 and the piston 22 to move upward to return to the top dead center, the locking block 51 switches to the locked state actuating the pressure bar 53 to trigger the position switch 82, and the control 81 determines that the striker 30 has returned to the top dead center based on the trigger signal from the position switch 82, whereby a next nail driving cycle may be performed smoothly. If the position switch 82 is inactivated when starting the next nail driving cycle, the control 81 may first instruct the electric motor 41 to drive the movable member 42 to move upward upon starting the next nail driving cycle, and the upward moving movable member 42 drives the striker 30 and the piston 22 to return to the top dead center, whereby the position switch 82 can be triggered by the pressure bar 53; the next nail driving cycle continues after the position switch 82 is triggered. Fitting between the position switch 82 and the pressure bar 53 ensures that the striker 30 and the piston 22 are both disposed at the top dead center upon start of the nail driving cycle, which ensures movement travel of the striker 30 performing the nail driving action and ensures nail driving effect. In this implementation, the position switch 82 is retained in the cavity enclosed by the second rest plate 1204 and the base cover 1202, the pressure bar 53 projecting into the cavity so that the pressure bar 53 sliding with the locking block 51 can trigger or release the position switch 82.

In this implementation, since the locking block 51 still contacts the striker 30 while migrating from the striker 30, an opened recess 5103 is provided at one side of the locking block 51 facing the striker 30 so as to mitigate friction between the locking block 51 and the striker 30, one end of the pressure bar 53 projecting into the opened recess 5103 of the locking block 51, a rolling member 54 sleeved outside the pressure bar 53 being provided in the opened recess 5103, an opposite end of the pressure bar 53 projecting out of the locking block 51 and aligned with the position switch 82. The locking block 51 in the unlocked state is pressed by the locking spring 5201 to contact the striker 30 via the rolling member 54; with the rolling friction between the rolling member 54 and the striker 30 in replacement of the sliding friction between the sliding block 51 and the striker 30, the friction applied by the sliding block 51 to the downward moving striker 30 is significantly diminished. Optionally, the rolling member 54 may adopt a member such as a bearing and a roller.

When the striker 30 moves upward to the top dead center, the locking spring 5201 presses the locking block 51 to abut against the striker 30 so that the locking block 51 slides to fit with the locking slot 51 to thereby lock the striker 30 to the top dead center, the locking block 51 sliding to the locked state actuates the pressure bar 53 to press against a button of the position switch 82 to thereby trigger the position switch 82, and the control 81 determines that the piston 22 and the striker 30 smoothly return to the top dead center based on the trigger signal of the position switch 82, so that the nail driving cycle can be performed normally when the nail gun starts a next nail driving cycle. Upon end of one nail driving cycle, if the upward moving piston 22 and the striker 30 fail to return to the top dead center, the locking block 51 cannot switch to the locked state so that the pressure bar 53 cannot press the button of the positions witch 82 failing to trigger the pressure switch 82; then the control 81 determines that the striker 30 and the piston 22 do not retreat in place, so that when the nail gun starts the next nail driving cycle, the control 81 first instructs the electric motor 41 to drive, via the gear 43, the movable member 42 to move upward, and the upward moving movable member 42 drives, via the transmission fit construction 62, the piston 22 and the striker 30 to synchronously move upward; when the position switch 82 is triggered, it is indicated that the piston 22 and the striker 30 have retreated in place, and then the next nail driving cycle is performed. Optionally, the position switch 82 may adopt a microswitch or another switch that can be automatically reset after being released.

To control the up-down movement travel of the movable member 42, a magnet 44 is exemplarily provided on the movable member 42, and two magnetic sensors 83 which are positionally retained and distributed at an interval in the up-down direction are provided on the stationary base assembly 12, the two magnetic sensors 83 communicating with the control 81, one of the magnetic sensors 83 being disposed corresponding to the movable member 42 moving downward to the bottom dead center, the other one of the magnetic sensors 83 being disposed corresponding to the movable member 42 moving upward to the top dead center. When the movable member 42 is actuated by the electric motor 41 to move downward till the lower magnetic sensor is triggered by the magnet 44, it indicates that the movable member 42 moves downward to the bottom dead center, so that the control 81 determines that the movable member 42 moves downward in place based on the trigger signal of the lower magnetic sensor, and then the control 81 instructs the electric motor 41 to halt. When the movable member 42 is actuated by the electric motor 41 to move upward till the upper magnetic sensor is triggered by the magnet 44, it indicates that the movable member 42 has moved upward to the top dead center, so that the control 81 determines that the movable member 42 has moved upward in place based on the trigger signal of the upper magnetic sensor, and then the control 81 instructs the electric motor 41 to halt. Optionally, the magnetic sensors 83 may adopt an electronic element which can output a signal based on magnetic field intensity change, such as a Hall sensor, a dry-reed switch, etc.

Exemplarily, the transmission fit construction 62 comprises a lower push surface 6201 arranged on the movable member 42 and an upper push surface 6202 arranged on the striker 30, the upward moving movable member 42 driving, via abutment fitting between the lower push surface 6201 and the upper push surface 6202, the striker 30 and the piston 22 to move upward to the top dead center. In this implementation, an upper end surface of the movable member 42 constitutes the lower push surface 6201, and the striker 30 is formed with an decreasing diameter from top to bottom and provided with a stepped surface, the stepped surface constituting the upper push surface 6202, the lower push surface 6201 being parallel to the upper push surface 6202.

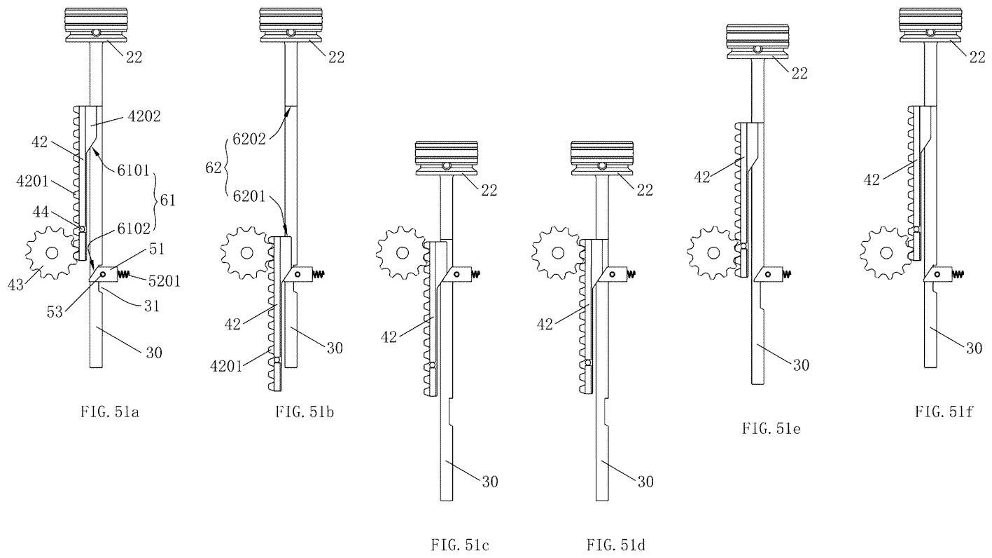

Referring to FIG. 51a, when the nail gun IT is inactivated, the locking block 51 is in the locked state under the prestress force of the locking spring 5201, the locking block 51 being fitted with the locking slot 31 on the striker 30 to limit the piston 22 and the striker 30 to the top dead center, the movable member 42 being disposed at the top dead center.

Referring to FIG. 51b, when the nail gun IT starts a nail driving cycle, the control 81 instructs the electric motor 41 to first drive the movable member 42 to move downward, and the movable member 42 when moving downward from the top dead center applies a force against the locking block 51 via abutment fitting between the first releasing beveled surface 6101 and the second releasing beveled surface 6102 so that the locking block 51 overcomes the prestress force of the locking spring 5201 to slide in a direction away from the striker 30.

When the movable member 42 moves downward till the lower magnetic sensor is triggered by the magnet 44, the movable member 42 moves to the bottom dead center, the control 81 instructs the electric motor 41 to halt, and the movable member 42 likely further moves a small distance under inertia; at the instant when the movable member 42 moves to the bottom dead center, the locking block 51 migrates out of the locking slot 31 on the striker 30; now, the locking spring 5201 is compressed under stress, releasing locking of the locking block 51 with respect to the striker 20 and the piston 22. Referring to FIG. 55c, at the instant when the locking block 51 migrates from the striker 30, the piston 22 is forced by the pressurized gas in the energy accumulation chamber 2101 to drive the striker 30 to rapidly move downward; the rapidly downward movement of the striker 30 drives the nail fed from the feeder assembly into an object such as wood, whereby nail driving is implemented. When the piston 22 moves downward to contact the shock absorption piece 26, the piston 22 and the striker 30 move downward to the bottom dead center; to prevent the striker 30 from bumping into the movable member 42, movement travel of the movable member 42 from the top dead center to the bottom dead center is slightly greater than movement travel of the striker 30 from the top dead center to the bottom dead center, so that when the movable member 42 is located at the bottom dead center and the striker 30 is located at the bottom dead center, certain space is left between the lower push surface 6201 and the upper push surface 6202.

Referring to FIGS. 51d and 5l, upon end of nail driving, the control 81 instructs the electric motor 41 to drive the movable member 42 to move upward from the bottom dead center, the upward moving movable member 42 drives, via abutment fitting between the lower push surface 6201 and the upper push surface 6202, the striker 30 and the piston 22 to move upward, and the upward moving piston 22 shrinks the volume of the energy accumulation chamber 2101, whereby the gas in the energy accumulation chamber 2101 is compressed.

Referring to FIG. 51f, when the upper magnetic sensor is triggered by the magnet 44, the control 81 determines that the movable member 42 moves to the top dead center based on the trigger signal from the upper magnetic sensor, and the control 81 instructs the electric motor 41 to halt; now, the piston 22 and the striker 30 move upward till the top dead center; at the instant when the striker 30 moves to the top dead center, the locking spring 5201 recovering from deformation drives the locking block 51 to slide towards the striker 30 so that the locking block 51 is fitted with the locking slot 31 to lock the striker 30 to the top dead center, whereby the locking block 51 is switched to the locked state and the pressure bar 53 triggers the position switch 82, and then the control 81 determines that the striker 30 and the piston 22 have returned to the top dead center based on the trigger signal from the position switch 82, so that a next nail driving cycle can be normally started. If the locking block 51 fails to smoothly switch to the locked state when the electric motor 41 halts driving the movable member 42, the pressure bar 53 cannot trigger the position switch 82, so that when starting the next nail driving cycle, the control 81 first instructs the electric motor 41 to drive the movable member 42 to move upward till the locking block 51 smoothly switches to the locked state, so that the pressure bar 53 triggers the position switch 82; then, the control 81 instructs the electric motor 41 to drive the movable member 42 to move downward to start the next nail driving cycle.

The electric components of the nail gun IT are electrically connected to or communicate with the control 81, and a trigger is provided on the handle 11, so that the user may start the nail driving cycle via the trigger.

Exemplarily, when the movable member 42 moves downward till the gear 43 meshes with the transmission tooth 4201 at the uppermost end of the movable member 42, the movable member 42 moves to the bottom dead center; and when the movable member 42 moves upward till the gear 43 meshes with the transmission tooth 4201 at the lowermost end of the movable member 42, the movable member 42 moves to the top dead center.

Optionally, the nail gun IT may be powered by a battery pack or powered by mains electricity connected via a wire.

### Tenth Implementation

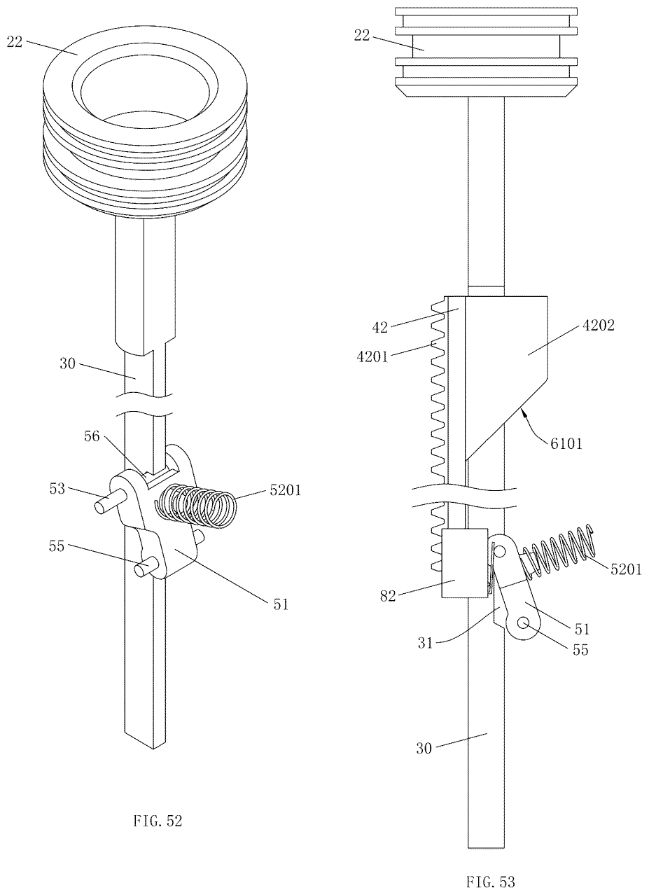

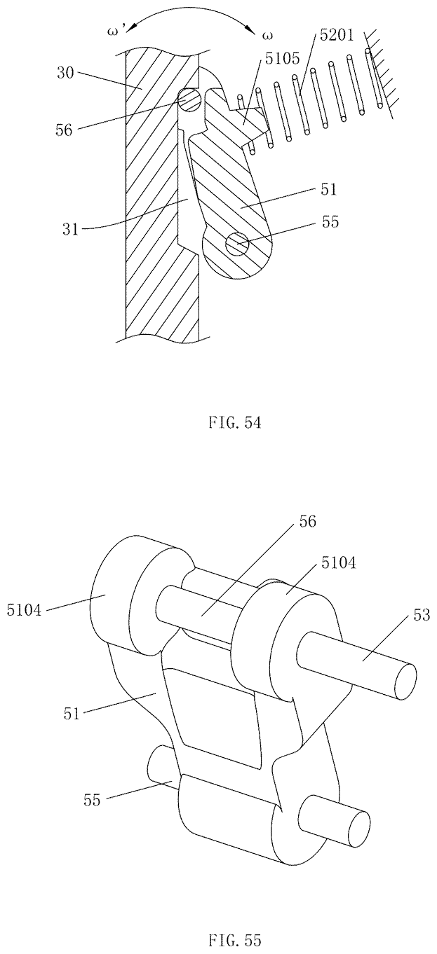

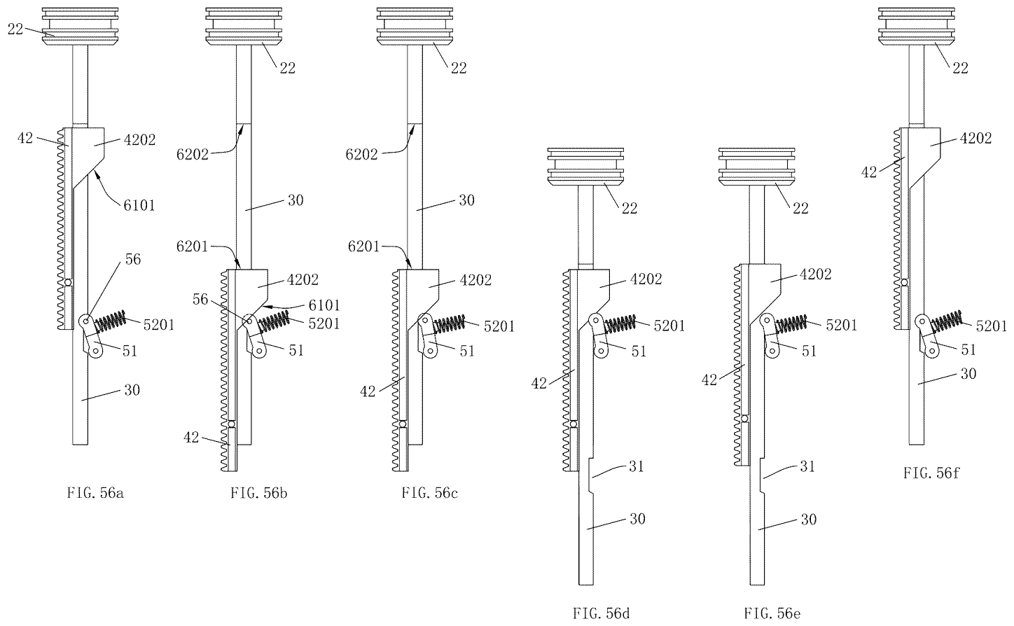

Referring to FIGS. 52 to 56f, in this implementation, the locking block 51 is pivotally arranged; the locking block 51 may pivot in a direction away from the striker 30 to switch to the unlocked state of migrating from the striker 30, and the locking block 51 may also pivot in a direction towards the striker 30 to switch to the locked state of fitting with the striker 30.

Specifically, the locking block 51 is arranged pivotal via a pin rod 55, two lugs 5104 distributed at an interval are provided at an end portion of the locking block 51 fitted with the striker 30, and the locking assembly 50 further comprises a locking rod 56 supported on the two lugs 5104, an axial direction of the locking rod 56 being substantially perpendicular to the lengthwise direction of the striker 30. When the locking block 51 is stressed to drive the locking rod 56 to overcome the prestress force of the locking spring 5201 to pivot in the direction indicated by ω, the locking rod 56 migrates from the locking slot 31 so that the locking block 51 switches to the unlocked state of releasing the striker 30, whereby the striker 30 can move downward to implement nail driving. When the striker 30 moves upward till the top dead center, the locking spring 5201 recovering from deformation drives the locking block 51 to bring the locking rod 56 to pivot in the direction indicated by ω′, so that the locking rod 56 enters the locking slot 31 and abuts against the inner wall of the locking slot 31 in an up-down direction, whereby the locking block 51 switches to the locked state of locking the striker 30 to the top dead center. Optionally, the locking block 51 may pivot back and force in the left-right direction or pivot back and force in the front-rear direction. Exemplarily, the locking rod 56 is rotatably supported on the two lugs 5104 in this implementation.

The locking block 51 is provided with a boss 5105 protruding away from the striker 30, one end of the locking spring 5201 being sleeved outside the boss 5105 and abutting against the locking block 51, an opposite end of the locking spring 5201 engaging the stationary base assembly so as to be positionally retained. The locking spring 5201 is compressed to force the locking block 51 to abut against the striker 30, so that the locking block 51 may drive the locking rod 56 to enter the locking slot 31 on demand.

In this implementation, the pressure rod 53 configured to trigger the position switch 82 may be formed by an extended segment of the locking rod 56; or, the pressure rod 53 may be separately provided relative to the locking rod 56 and secured on the locking block 51.

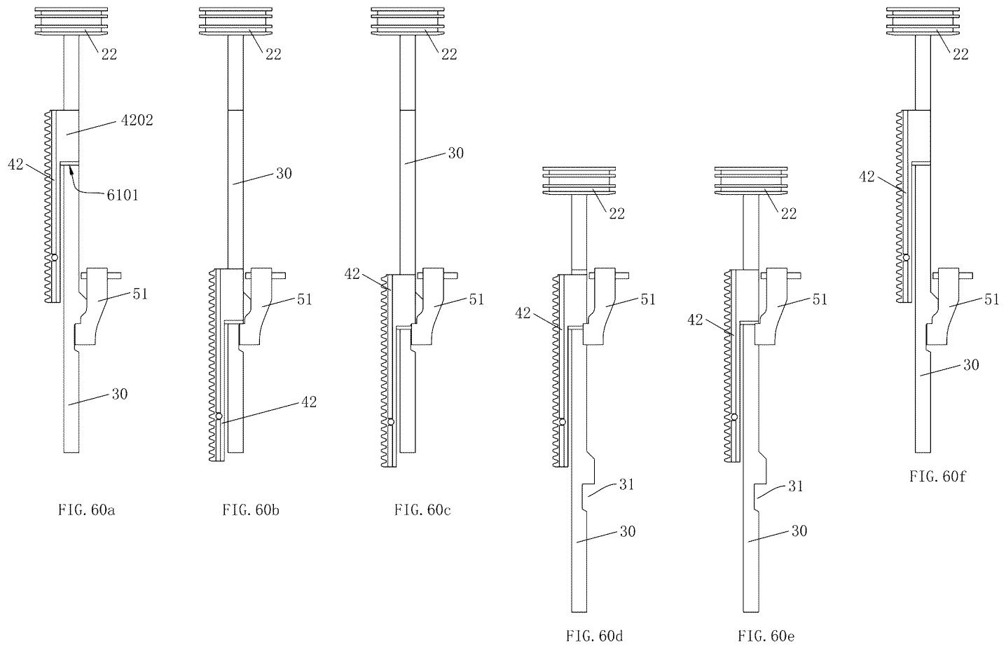

Referring to FIG. 60a, when the nail gun is inactivated, the locking block 51 is in the locked state under the prestress force of the locking spring 5201; the locking rod 56 is fitted with the locking slot 31 on the striker 30 to limit the piston 22 and the striker 30 to the top dead center, and the movable member 42 is disposed at the top dead center.

The remaining contents of the tenth implementation are identical to those of the ninth implementation, which will not be detailed here.

### Eleventh Implementation

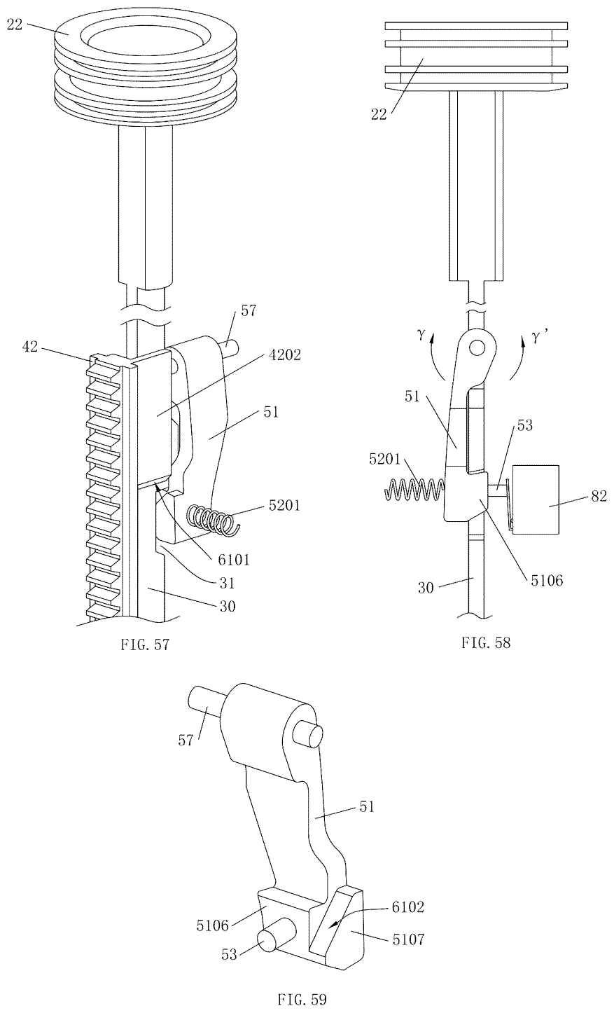

Referring to FIGS. 57 to 60f, in this implementation, the locking block 51 is pivotally disposed; the locking block 51 may pivot in a direction away from the striker 30 so as to switch to the unlocked state of migrating from the striker 30, and the locking block 51 may also pivot in a direction towards the striker 30 so as to switch to the locked state of fitting with the striker 30.

Specifically, the locking block 51 is disposed pivotal via a hinge rod 57, the hinge rod 57 being arranged at an upper end of the locking block 51, and a bump 5106 projecting towards the striker 30 and accessible into the locking slot 31 being arranged at a lower end of the locking block 51. Referring to FIG. 16, when the locking block 51 is stressed to overcome the prestress force of the locking spring 5201 to pivot in the direction indicated by y, the bump 5106 migrates out of the locking slot 31 so that the locking block 51 switches to the unlocked state of releasing the striker 30, allowing for the striker 30 to move downward to perform nail driving. When the striker 30 moves upward to the top dead center, the locking spring 5201 recovering from deformation drives the locking block 51 to pivot in the direction indicated by y′, so that the bump 5106 enters the locking slot 31 to abut against the inner wall of the locking slot 31 in an up-down direction, allowing for the locking block 51 to switch the striker 30 to the locked state of locking the striker 30 to the top dead center. Optionally, the locking block 51 may pivot back and force in the left-right direction and may also pivot back and force in the front-rear direction.

The locking block 51 is provided with a projection 5107 projecting towards the movable member 42, the second releasing beveled surface 6102 being arranged at a top side of the projection 5107 and oriented to face the widened portion 4202, the first releasing beveled surface 6102 being disposed at a lower end of the widened portion 4202 and oriented to face the projection 5107, the first releasing beveled surface 6101 and the second releasing beveled surface 6102 being exemplarily arranged parallel to each other.

The pressure bar 53 is disposed at one side of the locking block 51 facing the striker 30, and the locking block 51 pivoting towards the striker 30 may drive the pressure bar 53 to trigger the position switch 82.

In this implementation, the locking block 51 in the unlocked state substantially does not contact the striker 30.

The remaining contents of the eleventh implementation are identical to those of the ninth implementation, which will not be detailed here.

In addition to the exemplary implementations described supra, the present disclosure also has other implementations. All of such other implementations derived by those skilled in the art on the basis of those described herein without exercise of inventive work shall all fall within the scope of protection of the disclosure.

1. A fastener driving tool, comprising:
an energy accumulation assembly comprising a cylinder construction and a piston, the cylinder construction having an energy accumulation chamber, the piston being arranged in the cylinder construction, in the energy accumulation chamber being filled an energy accumulation medium, the piston moving to change a volume of the energy accumulation chamber so as to induce pressure change of the energy accumulation medium;
a striker connected to the piston, the piston driving the striker to move from a top dead center to a bottom dead center so that the striker drives a fastener into a workpiece;
and a drive assembly comprising a power unit and a drive wheel, the power unit driving, via the drive wheel, the striker and the piston to move upward from the bottom dead center to return in place;
wherein the power unit is provided with an output shaft, the drive wheel is fitted with the striker, the drive assembly is provided with a transmission construction, and the transmission construction has an engaged state and a disengaged state;
the output shaft transmits, via the transmission construction in the engaged state, power to the drive wheel to actuate the drive wheel to rotate forwardly, so that the drive wheel rotating forwardly drives the striker and the piston to move upward from the bottom dead center to return in place;
and the transmission construction is in the disengaged state during a process of the piston driving the striker to move from the top dead center to the bottom dead center; and the transmission construction in the disengaged state interrupts transmission of power from the output shaft to the drive wheel, so that the drive wheel fitted with the striker is driven to rotate reversely by the striker moving downwardly.

2. The fastener driving tool according to claim 1, wherein the drive assembly further comprises a rotary shaft, the drive wheel being arranged on the rotary shaft, the drive wheel and the rotary shaft rotating synchronously, the transmission construction being arranged between the output shaft and the rotary shaft or arranged between the output shaft and the drive wheel.

3. The fastener driving tool according to claim 2, wherein the transmission construction comprises a master wheel I driven to rotate by the output shaft and a slave wheel I arranged on the rotary shaft, one of the master wheel I and the slave wheel I being provided with a movable transmission rachet tooth, the other one thereof being provided with a transmission ratchet slot, the transmission ratchet tooth being inserted in the transmission ratchet slot so that the master wheel I and the slave wheel I are disposed in an engaged state, the transmission ratchet tooth migrating out of the transmission ratchet slot so that the master wheel I and the slave wheel I are disposed in a disengaged state.

4. The fastener driving tool according to claim 3, wherein the transmission construction further comprises a transmission spring biasing the transmission ratchet tooth towards the transmission ratchet slot, the transmission spring being deformed under stress when the transmission ratchet tooth migrates out of the transmission ratchet slot.

5. The fastener driving tool according to claim 3, wherein a concave is provided at one side of the master wheel I facing the slave wheel I, wheel I, the slave wheel I is received in the concave, the transmission ratchet slot is arranged on a side wall of the concave, the transmission ratchet tooth is movably arranged on the slave wheel I, and the transmission ratchet tooth migrating out of the transmission ratchet slot abuts against an inner wall of the concave.

6. The fastener driving tool according to claim 4, wherein the fastener driving tool further comprises a locating rod that is positionally retained, and the transmission ratchet tooth abutting against the locating rod overcomes a biasing force imposed by the transmission spring to migrate out of the transmission ratchet slot; and/or, the output shaft and the rotary shaft are concentrically arranged.

7. The fastener driving tool according to claim 2, wherein the transmission construction comprises a master wheel II actuated to rotate by the output shaft and a slave wheel II arranged on the rotary shaft, a driving tooth and a non-toothed portion being provided at an outer edge of the master wheel II, a plurality of driving teeth being arranged at intervals along a peripheral direction of the master wheel II, the non-toothed portion being arranged between the driving tooth at head and the driving tooth at tail, the slave wheel II meshing with the driving tooth of the master wheel II to dispose the transmission construction in an engaged state, the non-toothed portion interrupting mesh between the master wheel II and the slave wheel II to dispose the transmission construction in the disengaged state.

8. The fastener driving tool according to claim 1, wherein the transmission construction comprises a master wheel IV actuated to rotate by the output shaft, a transmission member radially movably arranged on the master wheel IV, a clutch carrier arranged between the master wheel IV and the drive wheel, a transmission slot provided on the drive wheel, and an elastic element II biasing the transmission member towards the transmission slot; the transmission member biased by the elastic element II is inserted in the transmission slot to dispose the transmission construction in the engaged state; and a bump allowing for the transmission member to overcome a biasing force imposed by the elastic element II to migrate out of the transmission slot is provided on the clutch carrier, the transmission member migrating out of the transmission slot to dispose the transmission construction in the disengaged state;
the bump has an abutting surface, the transmission member abutting against the abutting surface overcomes the biasing force imposed by the elastic element II to move in a direction of migrating out of the transmission slot, and the transmission member migrating from the bump is biased by the elastic element II to be re-inserted into the transmission slot.

9. The fastener driving tool according to claim 1, wherein the transmission construction comprises a master wheel V actuated to rotate by the output shaft, a slave wheel V rotating synchronously with the drive wheel, an elastic element III biasing the master wheel V towards the slave wheel V, a deflecting fork fitted with the master wheel V, and a driving block configured to drive the deflecting fork to slide axially; the master wheel V biased by the elastic element III is fitted with the slave wheel V to dispose the transmission construction in the engaged state; and the driving block rotating with the output shaft drives, via the deflecting fork, the master wheel V to overcome a biasing force imposed by the elastic element III to migrate from the slave wheel V so that the transmission construction is disposed in the disengaged state.

10. The fastener driving tool according to claim 9, wherein the transmission construction comprises a transmission shaft in transmission connection with the output shaft, the master wheel V and the driving block are arranged on the transmission shaft and rotate synchronously with the transmission shaft, and the slave wheel V and the drive wheel are rotatably sleeved on the output shaft.

11. The fastener driving tool according to claim 10, wherein the driving block is provided with a driving surface, the driving block when rotating actuates, via abutment between the driving surface (3551E) and the deflecting fork, the deflecting fork to drive the master wheel V to overcome the biasing force imposed by the elastic element III to move in a direction of migrating from the slave wheel V, and the deflecting fork migrating from the driving block allows for the master wheel V biased by the elastic element III to re-fit with the master wheel V.

12. The fastener driving tool according to claim 11, wherein the transmission shaft is provided with a disc body, the driving block is disposed at one side of the disc body facing away from the master wheel V, the elastic element III is arranged between the disc body and the master wheel V, and two ends of the elastic element III abut against the disc body and the master wheel V, respectively.

13. The fastener driving tool according to claim 12, wherein snap teeth and snap-in recesses peripherally distributed at intervals are provided on opposite end surfaces of the master wheel V and the slave wheel V, respectively, the snap teeth being inserted in the snap-in recesses so that the master wheel V and the slave wheel V are interlocked, the snap teeth migrating out of the snap-in recesses so that the master wheel V and the slave wheel V are disengaged; and/or an annular groove is arranged on an outer peripheral surface of the master wheel V, and a fork lever inserted in the annular groove is provided at one end of the deflecting fork.

14. The fastener driving tool according to claim 1, wherein the fastener driving tool further comprises a latch having a locked state and an unlocked state, the latch in the locked state is fitted with the striker to lock the striker, and the latch in the unlocked state migrates from the striker to release the striker.

15. The fastener driving tool according to claim 14, wherein the drive assembly comprises an unlocking member rotating with the output shaft or with the drive wheel, the unlocking member being operable to drive the latch to switch from the locked state to the unlocked state so that the striker is released by the latch;
and the fastener driving tool further comprises a locking spring biasing the latch towards the striker, the locking spring being configured to be compressed under stress when the latch switches from the locked state to the unlocked state, and to drive, when the striker returns in place, the latch released by the unlocking member to return to the locked state from the unlocked state.

16. The fastener driving tool according to claim 15, wherein an outer peripheral surface of the unlocking member comprises an arc-shaped surface and an avoidance surface disposed between two ends of the arc-shaped surface, a center of the arc-shaped surface coinciding with a rotational centerline of the unlocking member, the arc-shaped surface having a radius R, a distance between the avoidance surface and the rotational centerline of the unlocking member being less than R; the unlocking member when rotating drives, via abutment between the arc-shaped surface and the latch, the latch to switch to the unlocked state, the latch being retained in the unlocked state; and the unlocking member when rotating releases, via the avoidance surface, the latch to allow for the latch to return to the locked state;
or, a bulge protruding outward is arranged in a peripheral direction of the unlocking member, the unlocking member when rotating drives, via abutment between the bulge and the latch, the latch to switch from the locked state to the unlocked state, and the unlocking member when rotating drives the bulge to migrate from the latch to thereby release the latch;
or, a protrusion is arranged on an end surface of the unlocking member, the unlocking member when rotating drives, via abutment between the protrusion and the latch, the latch to switch from the locked state to the unlocked state, and the unlocking member when rotating allows for the protrusion to migrate from the latch to thereby release the latch.

17. The fastener driving tool according to claim 14, wherein the fastener driving tool further comprises a locking switch that is positionally retained, the locking switch being triggered by the latch returning to the locked state;
and/or, the striker has a ready position between a top dead center and a bottom dead center, center, the latch being fitted with the striker to lock the striker to the ready position, the transmission construction being in the engaged state during a process of the striker moving upward from the bottom dead center to the ready position and during a process of the striker moving upward from the ready position to the top dead center.

18. The fastener driving tool according to claim 1, wherein the power unit comprises an electric motor and a speed reducer, the output shaft being arranged on the speed reducer, a limiting construction limiting the output shaft to rotate unidirectionally being provided in the speed reducer.

19. The fastener driving tool according to claim 1, wherein the fastener driving tool further comprises a magnetic sensor that is positionally retained, a magnet configured to trigger the magnetic sensor is arranged on the striker or on the drive wheel, and the power unit performs braking or deceleration based on a signal of the magnetic sensor being triggered by the magnet,
and/or, the fastener driving tool further comprises a safety switch, an ejection rod configured to trigger the safety switch, and a stopper configured to limit the ejection rod, the stopper preventing the ejection rod from triggering the safety switch when a count of to-be-driven fasteners decreases to an alarm count.

20. A nail gun, comprising:
a housing, the housing being provided with a handle;
an energy accumulation assembly arranged in the housing, the energy accumulation assembly comprising a cylinder construction and a piston, the cylinder construction having an energy accumulation chamber, the piston being movably disposed in the cylinder construction, the piston moving to induce volume change of the energy accumulation chamber;
a striker connected to the piston, the striker and the piston having a top dead center and a bottom dead center, the striker being driven by the piston to move downward from the top dead center to the bottom dead center;
and a drive assembly comprising an electric motor and a movable member, the electric motor driving the movable member to move back and forth between the top dead center and the bottom dead center;
wherein the nail gun further comprises a locking assembly, the locking assembly having a locked state in which the locking assembly and the striker are fitted to lock the striker to the top dead center and an unlocked state in which the locking assembly migrates from the striker;
a fit releasing construction is arranged between the movable member and the locking assembly, the fit releasing construction driving the locking assembly to switch from the locked state to the unlocked state during a process of the movable member moving downward from the top dead center to the bottom dead center;
and a transmission fit construction that is engageable and dis-engageable is arranged between the movable member and the striker, wherein the movable member when moving upward drives, via the transmission fit construction, the striker and the piston to move upward from the bottom dead center to the top dead center so that the piston compresses an energy accumulation medium in the energy accumulation chamber to accumulate energy.
